(19) United States
(12) Patent Application Publication
(10) Pub. No.: US 2026/0189004 A1
(43) Pub. Date: Jul. 2, 2026

(54) Skidded String - Skid-Based Integrated Platform and Method for Operating Aggregated String Inverters

(71) Applicants: Zhehan Yi, Richardson, TX (US); Bryan Wagner, Richardson, TX (US); Anton Patton, Richardson, TX (US)

(72) Inventors: Zhehan Yi, Richardson, TX (US); Bryan Wagner, Richardson, TX (US); Anton Patton, Richardson, TX (US)

(21) Appl. No.: 19/420,677

(22) Filed: Dec. 15, 2025

Related U.S. Application Data
(60) Provisional application No. 63/740,118, filed on Dec. 30, 2024.

(51) Int. Cl. H02J 3/001; H02J 3/38; H02J 101/24

(52) U.S. Cl. CPC H02J 3/001; H02J 3/381; H02J 2101/25

(57) ABSTRACT

A Skidded String photovoltaic (PV) power conversion system includes a skid-based integrated platform that mechanically supports and electrically interconnects: multiple string inverters; at least one medium-voltage (MV) step-up transformer; at least one balance-of-system (BOS) and protection system including multiple overcurrent protection devices (OCPDs), and wherein the outputs of the multiple string inverters are aggregated at a low-voltage level and supplied to the MV transformer so that the skid-based platform operates as a virtual central inverter while maintaining independent inverter-level operation.

### BACKGROUND OF THE INVENTION

The present disclosure relates generally to solar photovoltaic power conversion systems.

Utility-scale and commercial photovoltaic installations increasingly demand high-efficiency, grid-compliant conversion from DC sources to AC distribution networks while meeting stringent requirements for reliability, maintainability, and rapid field deployment. Conventional architectures range from centralized inverters, which can offer cost advantages and simplified plant-level control but present single-point-of-failure and maintenance-access challenges, to fully distributed string inverters, which improve modularity and fault containment at the expense of increased wiring complexity and site coordination. Additionally, system designers must address inverter-level electrical isolation, fault detection and mitigation, compliance with grid codes for anti-islanding, reactive power support, and harmonic management, all within constraints of installation footprint, logistics, and lifecycle serviceability. These competing factors have driven interest in integrated, modular power conversion approaches and site-deployable equipment packages that balance operational robustness with installation efficiency.

### SUMMARY OF THE INVENTION

In one aspect, a Skidded String is a type of photovoltaic (PV) power conversion system, which includes a skid-based integrated platform that mechanically supports and electrically interconnects: multiple string inverters; at least one medium-voltage (MV) step-up transformer; at least one balance-of-system (BOS) and protection system including multiple overcurrent protection devices (OCPDs); wherein the outputs of the multiple string inverters are aggregated at a low-voltage level and supplied to the MV transformer so that the skid-based platform operates as a virtual central PV power conversion system while maintaining independent string inverter-level operation.

In another aspect, a method of operating a photovoltaic power conversion system as a virtual central inverter while maintaining inverter-level independence includes mechanically supporting on a skid-based integrated platform a plurality of string inverters, at least one medium-voltage step-up transformer, and at least one balance-of-system and protection system that includes a plurality of overcurrent protection devices. The method further comprises receiving direct-current power from a plurality of photovoltaic strings at respective string inverters and converting the direct-current power to low-voltage alternating current power at each string inverter, aggregating outputs of the plurality of string inverters at a low-voltage level via the balance-of-system and protection system while maintaining selective isolation of individual string inverters by the overcurrent protection devices, supplying the aggregated low-voltage alternating current power to a low-voltage winding of the medium-voltage step-up transformer, and exporting medium-voltage power from the medium-voltage step-up transformer for grid interconnection, thereby operating the skid-based integrated platform as a virtual central inverter with inverter-level fault tolerance.

In yet other aspects:
1. A method of operating a photovoltaic (PV) power conversion system as a virtual central inverter while maintaining inverter-level independence, comprising:
mechanically supporting, on a skid-based integrated platform, a plurality of string inverters, at least one medium-voltage (MV) step-up transformer, and at least one balance-of-system (BOS) and protection system including a plurality of overcurrent protection devices (OCPDs);
receiving direct-current (DC) power from a plurality of PV strings at respective ones of the string inverters and converting the DC power to low-voltage alternating current (LV AC) power at each string inverter;
aggregating outputs of the plurality of string inverters at a low-voltage level via the BOS and protection system while maintaining selective isolation of individual ones of the string inverters by the OCPDs;
supplying the aggregated LV AC power to a low-voltage winding of the MV step-up transformer; and

exporting medium-voltage power from the MV step-up transformer for grid interconnection, thereby operating the skid-based integrated platform as a virtual central inverter with string-inverter-level functionalities.
2. The method of claim 1, further comprising selectively opening a dedicated OCPD corresponding to a target string inverter to isolate the target string inverter without interrupting operation of remaining string inverters.
3. The method of claim 1, wherein the MV step-up transformer comprises one or multiple low-voltage windings, and the aggregating comprises supplying respective groups of the string inverters to corresponding ones of the multiple low-voltage windings.
4. The method of claim 1, wherein the BOS and protection system comprises at least one low-voltage switchboard that interconnects the plurality of string inverters to the low-voltage winding of the MV step-up transformer.
5. The method of claim 4, further comprising coordinating tripping of a main OCPD disposed between the switchboard and the low-voltage winding responsive to a fault exceeding a threshold at the switchboard output.
6. The method of claim 1, further comprising distributing auxiliary low-voltage power, derived from at least one auxiliary power transformer on the skid, to control, monitoring, communication, and cooling equipment mounted on or associated with the skid.
7. The method of claim 1, further comprising routing PV string conductors from a field installation to at least one DC connection box mounted on or within the skid, and prewired DC cables from the DC connection box to DC input terminals of the plurality of string inverters.
8. The method of claim 7, further comprising performing string-level DC protection or monitoring in the DC connection box using at least one of DC disconnect devices, fuses, current sensing components, or surge protection devices.
9. The method of claim 1, further comprising collecting, at a control center mounted on the skid, real-time operational data from each of the plurality of string inverters and transmitting the operational data to an upper-level power plant controller, data acquisition system, or supervisory control and data acquisition system.
10. The method of claim 9, further comprising receiving, at the control center, one or more commands comprising at least one of an active power setpoint, a reactive power setpoint, or a curtailment command, and distributing corresponding control signals to the plurality of string inverters.
11. The method of claim 1, wherein the aggregating comprises interconnecting string inverter outputs to the BOS and protection system using pre-cut and terminated LV power cables or LV busbars factory-installed on the skid.
12. The method of claim 1, further comprising physically separating DC and AC cable routing on the skid using dedicated trays, conduits, or channels to provide clearance for airflow and maintenance access.
13. The method of claim 1, further comprising factory-assembling and factory-testing the skid-based integrated platform, including verifying electrical connections, performing insulation resistance testing, confirming grounding continuity, and functionally testing the OCPDs prior to shipment.
14. The method of claim 13, further comprising configuring network addresses and communication parameters of the plurality of string inverters and verifying bidirectional communications with the control center during factory testing.
15. The method of claim 1, wherein the skid-based integrated platform comprises multiple mechanically separate but electrically interconnected skids, and the method further comprises interconnecting a first skid integrating the MV step-up transformer and a control center with a second skid integrating the plurality of string inverters and inverter-level OCPDs.
16. The method of claim 1, further comprising commissioning the PV power conversion system by verifying DC polarity and continuity, starting up the plurality of string inverters, and confirming protection coordination for inverter-level and main OCPDs.
17. The method of claim 1, further comprising maintaining partial power export during maintenance by isolating one or more of the plurality of string inverters using the corresponding OCPDs while continuing to aggregate power from remaining string inverters.
18. The method of claim 1, further comprising deploying multiple skid-based integrated platforms in parallel and coordinating setpoints via the upper-level power plant controller to scale plant capacity.
19. The method of claim 1, wherein at least one of the plurality of string inverters is a 250 kW class string inverter, and the aggregating and supplying steps are performed to realize an approximately 2.5 MW, 3 MW, 5 MW, or other power block ratings depending on the number of installed string inverters.
20. The method of claim 1, further comprising performing fault localization using inverter-level monitoring and BOS protection status at the control center to identify a faulted inverter or feeder prior to actuating selective isolation.

Advantages of one implementation may include one or more of the following:
Modular redundancy and fault tolerance: preserves inverter-level independence so a single string-inverter fault can be isolated by overcurrent protection without taking the entire platform offline, increasing system availability.
Virtual central-inverter behavior: enables coordinated, plant-level AC dispatch, grid-support functions (e.g., reactive power, ramp control, anti-islanding compliance) and monitoring while retaining distributed MPPT and per-inverter controls.
Rapid field deployment and reduced site labor: skid-based, factory-integrated assemblies reduce on-site assembly, wiring and commissioning time compared with field-built centralized systems.
Reduced installation footprint and simplified logistics: co-location of multiple string inverters, balance-of-system (BOS) components and one or more medium-voltage (MV) step-up transformers on a single skid minimizes site footprint and simplifies transport and placement.
Simplified MV interconnection and protection: aggregation at a low-voltage (LV) bus feeding an on-skid MV transformer concentrates interconnection equipment and protection, reducing MV cable runs and simplifying grid-connection interfaces.
Improved maintainability and serviceability: physically modular skids and selective overcurrent isolation support hot-swap or rapid replacement of individual inverters and BOS modules with minimal system disruption.
Lower BOS and cabling costs: LV-side aggregation reduces the number and length of LV-to-MV conductor runs and eliminates some distributed combiner/collection hardware typical of fully distributed architectures.
Enhanced safety and regulatory compliance: integrated protection, isolation features and coordinated control facilitate compliance with grid codes (anti-islanding, fault-ride-through, harmonics) and improve electrical-safety management for operations staff.
Thermal and environmental control efficiencies: centralized packaging allows optimized thermal management, enclosure protection and easier implementation of environmental controls for increased component life and reliability.
Scalability and flexible capacity planning: additional skids or inverter modules can be added to expand capacity while maintaining consistent plant-level behavior and interconnection arrangements.
Factory testing and quality control: pre-integrated platforms enable higher-fidelity factory acceptance testing (FAT) of electrical, protection and control interactions prior to shipment, lowering commissioning risk.
Improved monitoring and diagnostics: consolidated monitoring and protection points simplify data collection, fault diagnostics and predictive maintenance workflows.
Reduced single-point-of-failure exposure vs. conventional centralized inverters: while providing centralized MV aggregation, maintaining inverter-level isolation reduces the severity of component failures relative to a single large inverter.
Economic balance between centralized and distributed architectures: combines many advantages of central inverters (simplified MV interconnect, fewer transformers) with the operational and fault-containment benefits of distributed string inverters, potentially lowering life-cycle costs.
Transportability and repeatable deployment: a standardized skid design supports rapid replication across sites and eases permitting and installation planning.

These advantages may be realized in various configurations and depend on specific design choices, component selection, and grid interconnection requirements.

### BRIEF DESCRIPTION OF DRAWINGS

FIG. 1 is a block diagram of a single-skid Skidded String inverter system with a skid boundary and showing major components and interconnections.

FIG. 2 is a schematic diagram showing a string inverter DC and AC connection detailed with multiple PV arrays and individual overcurrent protection devices.

FIG. 3 is a block diagram of a single-skid Skidded String system with a centralized DC connection box and prewired DC cables to string inverters according to an embodiment of the present application.

FIG. 4 is a block diagram of a multi-skid (two-skid) Skidded String configuration showing distributed architecture with electrical.

FIG. 5 is a single-line electrical diagram of a 2.5 MW Skidded String system with ten 250 kW string inverters and single LV winding.

FIG. 6 is a single-line electrical diagram of a 5 MW Skidded String system with twenty 250 kW string inverters and dual LV windings.

FIG. 7 is a detailed single-line electrical diagram of a 2.5 MW Skidded String system utilizing CPS SCH250K-T-US-600 string inverters with RS485 communications.

FIG. 8 is a three-dimensional isometric view showing the mechanical realization of a Skidded String inverter system with physical skid layout.

FIG. 9 is a process flow diagram illustrating a method of operating a skid-based integrated platform as a virtual central inverter.

### DETAILED DESCRIPTION OF THE INVENTION

The technical solutions in the embodiments of the present application will be described below in conjunction with the accompanying drawings. It should be understood that the embodiments described are only examples and are not intended to limit the present application.

In the following description, terms such as “first” and “second” are used only for descriptive purposes and should not be understood as indicating or implying relative importance, nor should they be interpreted as implicitly specifying the quantity of the technical features. Therefore, features defined with “first,” “second,” and the like may explicitly or implicitly include one or more instances of such features. In the context of the present application, unless otherwise specified, the term “multiple” means two or more.

Unless otherwise clearly specified or defined, the term “connection” or “connect” should be understood in a broad sense. For example, “connection” may refer to a fixed connection, a detachable connection, or an integrated structure; it may be a direct connection or an indirect connection through an intermediate medium, such as cables, cable harnesses, hard busbars, or flexible busbars. The term “skid” may refer to a metallic platform which can be in the form of a plate, a container, a cabinet, or other structural base, which may or may not comprise multiple enclosures or doors. The term “integration” may refer to an electrically and/or mechanically connected arrangement. “Integration” may be achieved through direct connection or through one or more intermediate media, and may also encompass the mechanical racking and mounting methods used to support and secure components on or within the skid.

A Skidded String Inverter System is detailed for ground-mounted solar PV systems based on string PV inverters. The system includes a steel skid or container, a controller, N string PV inverters, and M protection devices (disconnect switches and/or circuit breakers) housed in a switchboard, where N and M are integers greater than or equal to 2. The system may optionally feature a medium voltage step-up transformer and an auxiliary power transformer with a distribution panel. Each string inverter is connected to one or more PV module arrays. Each protection device has one end linked to an AC bus and the other end connected to a string PV inverter. The controller facilitates communication for the string inverters within the skid/container and integrates with the plant-level controller. The system may also optionally feature one or multiple DC connection boxes mounted on or within the skid, which serve as a centralized DC interface between PV strings installed in the field and the multiple string inverters mounted on the skid. By scaling the number of string inverters, the system supports different power ratings. This design merges string and central inverter benefits, standardizes hardware architecture, simplifies maintenance, and reduces costs.

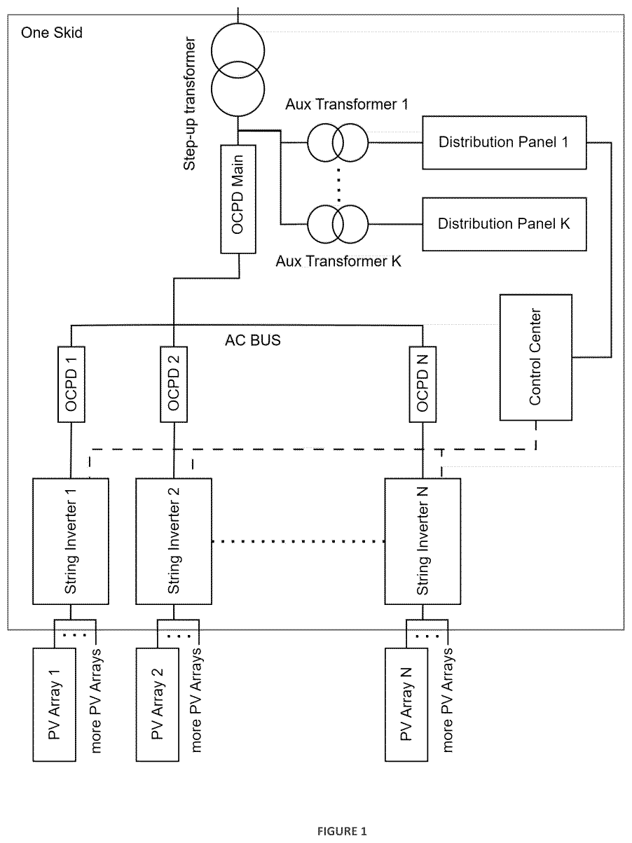

In some embodiments, a Skidded String system is provided as an integrated platform that combines multiple string inverters, a multiple-winding medium-voltage (MV) transformer, a combined Balance of System (BOS) and protection system including multiple protection devices, multiple auxiliary power transformers, and multiple distributed control panels on a single skid or on multiple interconnected skids. FIG. 1 illustrates a generic exemplary layout of such an embodiment. This innovative arrangement offers the adaptability and segmentation of string inverters while incorporating the simplicity and cost efficiency typically associated with central inverters. By centralizing these components, the Skidded String solution can optimize performance, maintenance, and communication within large-scale PV installations.

In other embodiments, systems and methods are disclosed for operating a photovoltaic power conversion system as a virtual central inverter while preserving inverter-level independence. This is done by mechanically supporting on a skid-based integrated platform a plurality of string inverters, at least one medium-voltage step-up transformer, and a balance-of-system and protection arrangement including overcurrent protection devices. DC power from PV strings is received at the string inverters and converted to low-voltage AC, the string inverter outputs are aggregated at the low-voltage level via the BOS while maintaining selective isolation of individual inverters with dedicated OCPDs, and the aggregated low-voltage AC is supplied to a low-voltage winding of the MV step-up transformer for export to the grid to realize inverter-level fault tolerance. The method further contemplates grouping inverters onto multiple low-voltage windings, a low-voltage switchboard with coordinated main OCPD tripping, auxiliary power distribution for control/monitoring/cooling, DC connection boxes and prewired DC cables with string-level DC protection, a skid-mounted control center for monitoring and bidirectional command distribution including active/reactive setpoints and curtailment, factory assembly and testing with communications configuration, physical separation of DC and AC routing, multi-skid electrical interconnection, commissioning and protection coordination, selective isolation to maintain partial export during maintenance, parallel deployment and coordinated setpoint control to scale capacity (e.g., aggregating 250 kW class inverters to form approximately 2.5, 3 or 5 MW power blocks), and inverter-level monitoring/BOS status-based fault localization prior to selective isolation.

In some embodiments, the system incorporates multiple string inverters, each linked to a specific set of PV strings. These inverters allow the PV array to be segmented into modular units, enabling independent operation and quick isolation for maintenance, thereby enhancing system resilience and maximizing energy yield. The modular structure also allows the system to dynamically adjust to changes in solar generation, shading, and localized fault conditions, providing real-time adaptability.

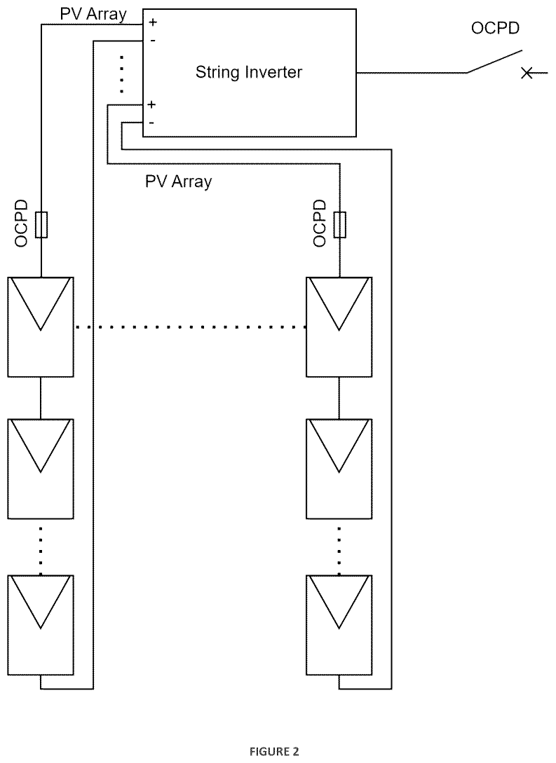

Each string inverter may be connected to one or multiple PV arrays at its input terminals and export AC power at its output terminals. Each PV array can be configured with modules connected in series and/or in parallel before being connected to the inverter's input terminals, as schematically shown in FIG. 2. In some embodiments, the number of PV arrays per inverter, and the series/parallel configuration, may be selected according to desired DC voltage, current, and power ratings.

FIG. 2 illustrates an example of how a string inverter is connected on its DC and AC sides to multiple PV arrays and protection devices. The figure shows at least two PV arrays, each formed by series-connected PV modules, feeding the positive and negative DC input terminals of a single string inverter. Each PV array string includes its own DC overcurrent protection device (OCPD) so that an individual string can be isolated without shutting down the other strings connected to the same inverter. On the AC side, the output of the string inverter is connected through an AC OCPD (such as a breaker or switch) to the downstream AC collection system, allowing the inverter to be disconnected from the AC bus for maintenance or fault clearing.

In one embodiment, a plurality of string inverters are mounted within the skid boundary and arranged to receive direct-current inputs from associated photovoltaic strings and produce synchronized three-phase reduced-voltage alternating-current outputs, for example at 480 V or 600 V. Each inverter is connected by a dedicated feeder to the reduced-voltage switchboard, where the feeder is provided with an overcurrent protection device and can be paired with an AC isolation switch 8 for service operations. The inverters operate in parallel on the reduced-voltage bus with independent maximum power point tracking and grid-support functions while maintaining feeder-level isolation so that a trip, fault, or maintenance event affecting one inverter does not interrupt operation of remaining inverters. In an exemplary configuration, ten inverter feeders are implemented with the combined reduced-voltage output delivered from switchboard to the reduced-voltage winding of the step-up transformer for aggregation and export at medium voltage. Operational status, alarms, and control parameters from the inverters are communicated over the RS-485 data stream to the communications gateway for supervisory control and data acquisition integration.

At operation S102, direct-current power from a plurality of photovoltaic strings is delivered to respective inputs of string inverters mounted within the skid boundary. Each string inverter receives incoming DC within its allowable operating window and performs maximum power point tracking on one or more DC inputs to regulate string voltage and current. The DC inputs can be conditioned by inverter-integrated protections, such as DC disconnects, surge protection, and input fusing, to permit isolation of a given PV string without interrupting service to the remaining inputs.

The regulated DC is converted at each string inverter into reduced-voltage alternating current, typically a three-phase AC output suitable for aggregation. Inverter controls synchronize phase, frequency, and voltage to a common reference and command real and reactive power in accordance with grid or plant setpoints. The resulting reduced-voltage AC output of each inverter is provided to its respective feeder toward the reduced-voltage switchboard, optionally through an associated AC isolation switch, so that each inverter operates independently while producing reduced-voltage AC power for subsequent aggregation.

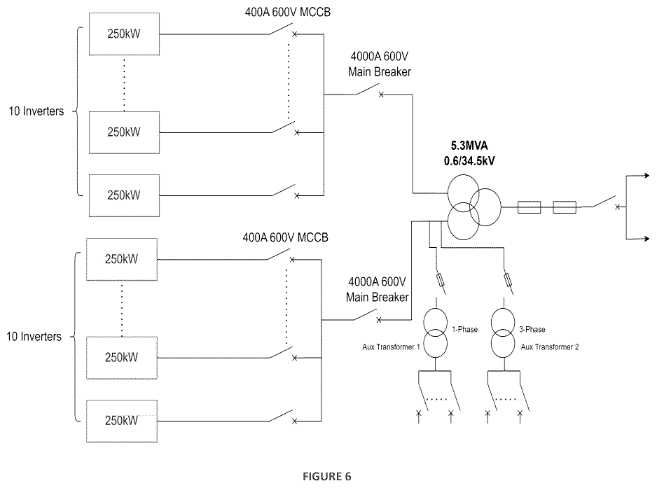

In some embodiments, the skid includes an MV transformer configured to step up the combined AC output from the string inverters to an appropriate medium-voltage level for grid interconnection. The MV transformer can be constructed with multiple low-voltage (LV) windings as needed. For example, in an embodiment with two LV windings, a first LV winding can be electrically connected to a first group of string inverters, while a second LV winding can be electrically connected to a second group of string inverters, as illustrated in FIG. 6.

The transformer serves as a centralized transmission point for the inverters mounted on the skid, thereby minimizing AC cabling requirements and reducing power losses associated with transmission. Locating the transformer on the same skid with the inverters, BOS, and control equipment can reduce overall BOS costs, simplify installation, and optimize the system footprint.

In another aspect, a medium-voltage step-up transformer is mounted within skid boundary that electrically couples the LV bus of switchboard to the medium-voltage feeder associated with protection and metering assembly. Its LV winding is connected to the aggregated three-phase output of string inverters and accepts approximately 0.6 kV class power, while its medium-voltage winding delivers approximately 34.5 kV class power to the feeder for grid interconnection. The transformer provides galvanic isolation, voltage transformation, and fault current moderation through leakage impedance coordinated with downstream and upstream overcurrent protection devices, and is capable of employing a delta-connected LV winding with a grounded-wye medium-voltage winding to establish a stable neutral and mitigate triplen harmonics. The unit can include no-load taps for voltage adjustment, surge arresters on the medium-voltage side, temperature and condition sensors for monitoring, and provisions for neutral grounding. LV terminations are arranged for bus or cable connection to switchboard, and medium-voltage terminations interface to the protection and metering equipment. By stepping the aggregated LV power to the medium-voltage level, transformer facilitates export to the grid while maintaining inverter-level selectivity achieved on the LV side.

The aggregated inverter-side AC bus is coupled to a secondary winding of the medium-voltage step-up transformer so that the combined inverter AC power is stepped up and exported at medium voltage for grid interconnection. The transformer and inverter-side bus are designed to ensure voltage, phase and frequency alignment of the aggregated inverter outputs; individual inverters typically operate with synchronized carriers and either grid-following or grid-forming control so their summed output appears on the MV side as a single, coherent AC source. Plant-level coordination or supervisory control is configured to modulate inverter setpoints (e.g., active power, reactive power, power factor, ramp rates) such that the skid functions as a virtual central inverter and meets grid interconnection requirements for voltage regulation, frequency response, and fault ride-through.

In step S106, the aggregated alternating current from the inverter-side switchboard, which combines the outputs of the string inverters while maintaining feeder selectivity through the overcurrent protection devices and associated AC isolation switches, is conveyed via busbars or cables to the primary winding of the step-up transformer. The transformer's primary receives the three-phase source at the prescribed voltage and frequency and magnetically couples it for elevation to medium voltage, handing off the transformed power to the medium-voltage side equipment in the subsequent export stage. Operational setpoints used to condition the transformer input, including voltage, frequency, and power factor, can be coordinated through commands delivered from the communications gateway 6 over the inverter data link.

The MV step-up transformer comprises multiple secondary windings, and the secondary-side switchboard and associated BOS are arranged to supply respective groups of string inverters to corresponding secondary windings. Each secondary winding is coupled to a discrete secondary bus or bus section so that a subset of the plurality of string inverters is electrically aggregated onto that winding through the BOS and feeder OCPDs. Feeder-level AC isolation switches and OCPDs permit selective physical and overcurrent isolation of individual inverter feeders on a per-winding basis without interrupting aggregation on other windings, preserving generation from unaffected inverter groups. Aggregation at multiple secondary windings enables redundancy and fault tolerance: an internal inverter fault, an OCPD trip, or maintenance action isolating a particular secondary winding or one or more feeders affects only the corresponding inverter group and winding, while the remaining windings continue to supply secondary-side power to the transformer and thus continue exporting MV power.

The multiple LV windings can be connected in various ways on the MV side to satisfy grid interconnection requirements. In one arrangement, the LV windings are magnetically isolated and their MV-side windings are tied to a common MV winding to produce a consolidated MV output, enabling the skid-based platform to operate as a virtual central inverter. In another arrangement, LV windings are assigned to separate phases or separate MV outputs to provide load distribution, phased balancing, or staged commissioning. Tap changers, selection of winding impedance, or active balancing controls can be employed to equalize contributions from each LV winding and to limit circulating currents when windings are paralleled on the MV side.

Control and communications infrastructure supports coordinated operation of the grouped inverter-to-winding architecture. RS-485 links or other inverter communications feed a communications gateway which forwards inverter-level data and receives commands from plant-level control systems (SCADA/DAS/PPC). Such supervisory control enables grouping strategies including dynamic reallocation of inverter feeders among windings, selective shedding, reactive power dispatch per winding, and ride-through coordination to meet utility interconnection rules. Protection and metering on the MV side monitor aggregate power export and provide MV protection independent of individual LV winding faults.

Mechanically integrating the inverters, BOS, OCPDs, MV step-up transformer with multiple LV windings, isolation switches, and metering/protection on a skid simplifies field installation, facilitates pre-commissioning of grouped windings, and reduces balance-of-plant complexity. The multiple-winding transformer configuration thereby retains inverter-level fault tolerance and maintenance isolation while delivering aggregated MV export consistent with a virtual central inverter paradigm.

In some embodiments, the combined BOS and protection system includes multiple overcurrent protection devices (OCPDs) which may be implemented as circuit breakers, fuses, disconnect switches, or combinations thereof. The OCPDs are organized as one or multiple LV switchboards that provide overcurrent protection and electrically connect each inverter to the low-voltage side of the MV transformer.

Each string inverter output may be connected to a dedicated OCPD within a switchboard so that the corresponding inverter can be selectively isolated. One or multiple main OCPDs may be disposed between the output of the one or more switchboards and the low-voltage terminals of the MV transformer. In this way, the BOS and protection architecture allows for selective fault isolation, enabling maintenance or troubleshooting of specific inverters or groups of inverters without disrupting operation of the entire system.

By centralizing the BOS and protection functions in one or more switchboards mounted on the skid, system reliability and safety can be improved, wiring complexity can be reduced, and installation costs can be lowered. The centralized protection scheme supports efficient fault management, allowing rapid fault localization and isolation and thereby minimizing downtime.

The switchboard is a skid-mounted assembly that receives the three-phase outputs from the plurality of string inverters and combines those outputs onto a common bus for delivery to the inverter-side winding of the step-up transformer. The switchboard includes a set of feeder overcurrent protection devices for the individual inverter feeders, each feeder being landed on its own protective pole set so that any one inverter can be selectively isolated without interrupting operation of the remaining inverters. The protective devices can be molded-case circuit breakers or fused switches coordinated for selective tripping, with shunt-trip or undervoltage-release accessories to enable remote trip and lockout during abnormal conditions or maintenance. The bus structure is rated for the aggregated kVA of the connected inverters and for the service voltage class shown, with copper busbars, a neutral bus where applicable to the transformer winding configuration, and an equipment grounding bus bonded in accordance with applicable codes.

The switchboard comprises phase and neutral busbars, surge protective devices, and provisions for LV-side metering and monitoring points for per-feeder current, voltage and power measurements. Feeder-level instrumentation is communicable to a local communications gateway via RS-485 or equivalent serial/data links, enabling inverter-level monitoring and control. The switchboard includes provisions for ground-fault detection and neutral handling compatible with the transformer winding configuration, and is configured to incorporate grounding jumpers or a switchable neutral bonding link to support different site grounding schemes.

An LV feeder output from the switchboard couples to the LV winding of the MV step-up transformer via a dedicated LV switchgear connection. This connection can include LV fused or non-fused disconnects, LV-side metering CTs and PTs, and protective relays coordinated with medium-voltage protection. Protective coordination is arranged so that feeder-level overcurrent protective devices (OCPDs) clear inverter-related faults located upstream of the LV bus, while transformer and MV-side protection address higher-level fault conditions, preserving selective isolation and minimizing plant-level disturbance. Thermal management for the switchboard and associated components is provided by ventilation, forced-air cooling, and ambient monitoring sensors mounted on the skid.

The LV switchboard is mechanically integrated within the skid boundary and arranged to minimize cable runs between the inverters and the transformer, reducing energy losses and easing installation. Modular feeder sections enable scalable inverter counts and simplify replacement. The switchboard provides plant control functions that realize virtual central-inverter behavior: aggregated LV power is smoothed, bus limits are enforced, and dispatchable setpoints received from a supervisory controller or PPC are applied at the inverter level via the communications gateway. Redundant communications and selective bypass pathways in the switchboard improve availability and enhance inverter-level fault tolerance.

In one embodiment, each inverter feeder of the LV switchboard is associated with a dedicated overcurrent protection device (OCPD) that is operable to be selectively opened to isolate a target string inverter while permitting uninterrupted operation of the remaining string inverters. The dedicated OCPDs are arranged on the aggregated LV bus such that opening a single OCPD removes the electrical connection between the corresponding string inverter and the common LV bus without opening other feeder OCPDs or interrupting power flow from the other inverters to the MV step-up transformer. The dedicated OCPD can be implemented as a thermal-magnetic circuit breaker, molded-case circuit breaker, fused disconnect, or a solid-state switching device suitable for interrupting the expected inverter fault current, and can include integrated trip sensing and status indication.

Control of the dedicated OCPDs is effected locally by the BOS and protection system or via commands from a communications gateway that receives status and alarms over the RS-485 data stream from the string inverters. In a fault-tolerant mode, the string inverter or the BOS protection logic detects an overcurrent, ground-fault, islanding condition, or other abnormal condition at a particular feeder and initiates a coordinated sequence in which the associated inverter is commanded to cease injection into the LV bus (for example by a controlled ramp-down of its output), followed by opening of the corresponding dedicated OCPD to ensure electrical isolation. Alternatively, an operator at a remote SCADA/DAS/PPC system issues a command through the communications gateway to open a selected OCPD for maintenance or testing. Status signals indicating the open or closed condition of each dedicated OCPD are reported back to plant-level control systems to confirm isolation.

Inverter-level independence is preserved through the selective isolation capability of the BOS: when an inverter or feeder develops a fault, its associated OCPD and AC isolation switch can disconnect that feeder without interrupting the aggregated LV bus or forcing shutdown of neighboring inverters. This architecture provides fault tolerance and continuous delivery of power to the transformer and grid even when one or more inverters are taken offline for maintenance or due to failure. The inclusion of AC isolation switches and accessible feeder terminations facilitates maintenance and replacement of individual inverters while preserving overall system integrity and service continuity.

In another aspect, AC isolation switches are assigned to the individual inverter feeders and installed between each string inverter and the corresponding feeder connection in the LV switchboard. Each switch provides a load-break, visible-open, lockable disconnect to permit maintenance and lockout/tagout of a selected string inverter without de-energizing the inverter-output bus or interrupting other inverter feeders. The switches coordinate with the feeder overcurrent protection devices housed in switchboard so that fault interruption is performed by the OCPDs while the switches provide electrical isolation and protection for personnel. The switches are rated for the inverter output voltage and current, simultaneously open all phase conductors, and are mounted on skid adjacent to the associated inverter cabinets for clear identification and access. Actuation of a switch isolates the corresponding inverter while the remaining inverter feeders continue supplying the inverter-output bus and the step-up transformer.

The DC disconnect devices are configured to provide lockable, visible-break isolation to facilitate maintenance and lockout tagout procedures prior to operation of AC isolation switches or other upstream equipment. The series fuses are arranged so that clearing a fault on a single string prevents propagation of DC overcurrent into the inverter input stage, thereby preserving selective string-level isolation without requiring shutdown of other strings aggregated at the reduced-voltage switchboard.

A coordinated tripping protection scheme is implemented to ensure selective isolation of faults at the distribution switchboard while preserving platform-level export capability. Current sensing devices, such as current transformers (CTs) or sensing elements on the switchboard, continuously monitor the aggregated distribution bus current. The switchboard incorporates a local protective controller or microprocessor relay programmed with time-current characteristics and threshold settings. Individual feeder OCPDs are configured to provide first-level, selective isolation for overcurrent conditions originating on or near an inverter feeder. The main OCPD located between the switchboard and the secondary winding of the medium-voltage step-up transformer is arranged to operate as a backup and as an elevated-threshold clearing device for faults that exceed the capability or selective-clearing range of the feeder OCPDs.

Optionally, fast communications such as zone-selective interlocking (ZSI) or direct signaling via the communications gateway can be used to expedite coordination: feeder-level devices are configured to send blocking or permissive signals to the main OCPD to prevent unnecessary main trips while a feeder clears a fault, or, conversely, to indicate failure to clear, allowing the main to operate faster. Trip events and status are reported via the communications gateway to supervisory systems (SCADA/DAS/PPC) for logging, automated plant control, and operator notification. Manual isolation using AC isolation switches remains available for maintenance, and automatic reclosing is inhibited where required by utility interconnection rules or until operator verification. Settings are selected to limit inverter contribution to fault current consistent with inverter capabilities and to preserve inverter-level fault tolerance while protecting the transformer and the medium-voltage network.

In another aspect, medium voltage protection and metering components are disposed on the MV side of the step up transformer and coupled to the utility or plant MV feeder. The medium voltage protection and metering component includes metal enclosed switchgear or a pad mounted recloser with a vacuum circuit breaker or load interrupter switch, protective relays, instrument transformers for protection and revenue metering (CTs and PTs), surge arresters, a visible break disconnect and optional grounding switch, and the required control power and wiring. The protective relay implements ANSI functions such as 27/59, 81U/81O, 81R, 50/51, 50N/51N or 67/67N, 46/47, 25, and 50BF, and is arranged to trip the MV interrupting device to clear feeder or transformer faults while coordinating with the secondary side OCPDs in switchboard to maintain inverter level selectivity. CT and PT secondaries provide inputs to both the protective relay and a revenue grade meter, enabling point of interconnection measurements and event recording. Status, alarms, measurements, and controls from Medium-voltage protection and metering component interface with the communications gateway for SCADA/DAS/PPC integration, allowing remote indication, permissives, and trip/close commands subject to relay supervision. Sync check and anti islanding logic supervise MV closing and initiate opening upon loss of source or out of tolerance conditions. The assembly is factory integrated on the skid boundary with MV terminations to the feeder and is provided in common voltage classes (for example 5-38 kV) with interrupting and metering accuracies specified by the interconnecting utility.

Additional BOS and MV-side equipment such as medium-voltage protection relays, metering, surge protection, and a communications gateway are included on the skid to support protection, monitoring, and integration with supervisory control and data acquisition (SCADA) or plant power control systems. Communications from inverters to the gateway (for example via RS-485 or Ethernet) convey operational data and allow remote setpoint changes. The skid-based arrangement reduces site wiring, simplifies commissioning, and enables factory testing of the integrated system prior to field installation, while providing the performance and controllability characteristics of a central inverter with the redundancy and modularity of distributed string inverters.

### DC Connection Box and Prewired DC Cabling

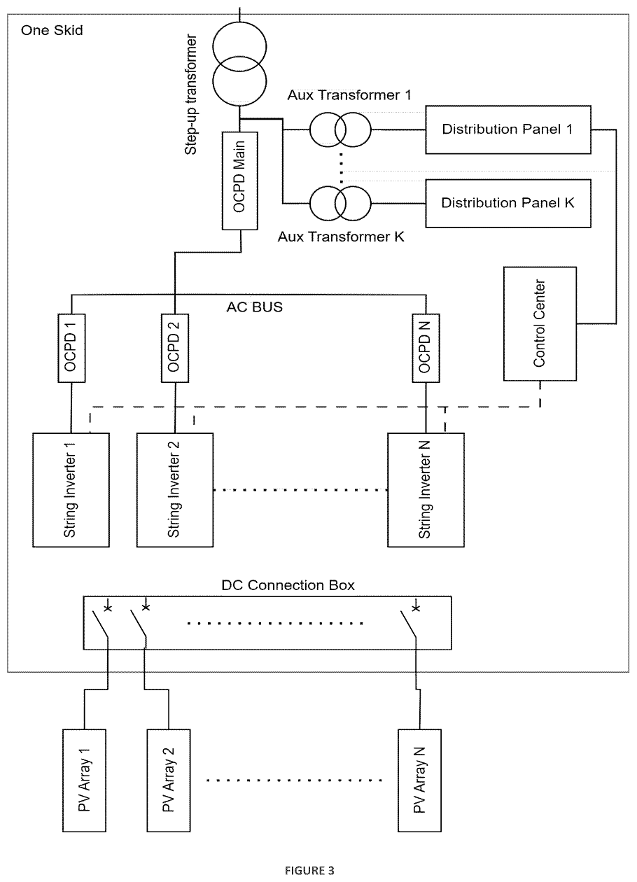

In some embodiments, the Skidded String solution further comprises one or multiple DC connection boxes mounted on or within the skid. The DC connection box is configured to serve as a centralized DC interface between PV strings installed in the field and the multiple string inverters mounted on the skid, as illustrated in FIG. 3. In these embodiments, the DC connection box includes a plurality of DC input terminals configured to receive DC conductors from PV strings routed from the PV array field. The DC connection box further includes a plurality of prewired DC output cables or conductors, each DC output cable being electrically connected to a corresponding DC input terminal of a respective string inverter mounted on the skid. In this manner, the DC connection box and the string inverters form a pre-integrated DC interconnection assembly.

The DC connection box may be implemented as one or more enclosures, and may include DC terminal blocks, DC connectors, cable glands, grounding terminals, and optional DC protection or monitoring components, depending on system design requirements. In some embodiments, the DC connection box may include string-level fusing, DC disconnect devices, current sensing components, or surge protection devices, while in other embodiments such protection functions may be implemented within the string inverters themselves.

By providing prewired DC cables between the DC connection box and each string inverter on the skid, the PV strings from the field can terminate at the DC connection box directly, without requiring individual field-installed DC cable routing to each inverter enclosure. This arrangement significantly reduces field labor, cable management complexity, and installation time, particularly in large-scale PV installations with a high number of string inverters.

Additionally, centralizing DC terminations in the DC connection box simplifies installation planning and improves consistency and quality of field wiring. The DC connection box allows installers to perform DC connections in a consolidated location, reducing the risk of wiring errors and improving overall safety during installation and commissioning. The prewired nature of the DC cabling between the DC connection box and the string inverters further enables factory-level quality control, reduces on-site variability, and facilitates faster commissioning.

The skid-based integrated platform further includes one or more DC connection boxes mounted on or within the skid to receive PV string conductors routed from the field installation. PV string conductors are routed from the array via underground or above-grade trenching and conduit to an ingress location on the skid, where the conductors are terminated at the DC connection box using cable glands or other suitable strain-relief and sealing fittings. The DC connection box provides a dedicated, centralized point for string-level terminations and can incorporate string fusing, DC surge protection devices, string-level monitoring or combiner functionality, and labeled terminal blocks to facilitate orderly connection and diagnostics. From the DC connection box, prewired DC cables or harnesses are routed to each string inverter, with each prewired cable terminating at the corresponding DC input terminals of the string inverter. The prewired DC cables are factory assembled or pre-terminated at the skid to reduce field labor, minimize on-site wiring errors, and shorten commissioning time. Prewiring includes appropriately sized conductors, lugs or connector assemblies compatible with the inverter DC input, and protective sleeving or conduit routing along the skid to maintain mechanical protection and accessibility for maintenance.

Current sensing components in the DC connection box provide continuous monitoring of each string's operating current. Sensor outputs are routed to local protection logic or to the associated string inverter control, enabling detection of current asymmetries, ground-faults, reverse current, or hot-spot conditions. Where present, conditioned sensor signals and fault indications are communicated via the inverter communications interface (e.g., Modbus over RS-485) to communications gateway for forwarding to SCADA/DAS/PPC, or directly to on-skid control logic. Detected DC fault conditions can trigger automatic actuation of DC disconnects, issuance of inverter stop commands, targeted opening of AC OCPDs housed in the service-voltage switchboard, or other protective measures coordinated to preserve continuity of service for unaffected strings and maintain inverter-level fault tolerance.

Surge protection devices are coordinated with grounding and lightning protection practices for the skid-based platform to divert surge currents to ground rather than into inverter inputs or the transformer secondary bus feeding the MV step-up transformer. The DC connection box is mechanically supported on the skid and is configured as a modular, replaceable assembly to facilitate commissioning, testing, and field service while ensuring compliance with applicable electrical codes and interconnection requirements.

### Auxiliary Power System

In some embodiments, the Skidded String solution further comprises one or multiple auxiliary power transformers configured to supply low-voltage power to control and monitoring equipment, cooling units, tracker systems, communication devices, and/or other auxiliary systems located on or outside of the skid. The auxiliary transformers may derive their primary supply from the LV bus, from a dedicated inverter output, or from another suitable source.

At least one auxiliary step-down transformer is mounted on the skid to derive auxiliary reduced-voltage power for local control, monitoring, communication, and cooling loads associated with the skid. The auxiliary transformer is coupled to an appropriate tapped point of the skid power system (for example from the aggregated inverter output bus supplied by the plurality of string inverters or from a dedicated auxiliary winding of the MV step-up transformer) and provides one or more secondary voltages required by on-skid equipment, such as 120/240 VAC service for motor loads and panelboards, 24-48 VDC for control and telecommunication equipment, and isolated control circuits for safety functions. An auxiliary distribution panel, located within the local switchboard or in a dedicated enclosure on the skid, receives the auxiliary transformer output and distributes power via fused or breaker-protected feeders to inverter control cabinets, communications gateway(s), RS-485 transceivers, supervisory RTUs/PLCs, metering and sensing devices, and transformer and inverter cooling fans and heaters.

Overcurrent protection devices and AC isolation switches provide protection and selective isolation for auxiliary feeders, coordinated with the BOS protection scheme to permit maintenance activities and to prevent nuisance trips on primary generation feeders. Where uninterrupted operation of monitoring and control functions is required, the auxiliary distribution includes an uninterruptible power supply (UPS) and battery backup fed from the auxiliary transformer secondary or from a dedicated DC bus; the UPS supports communications gateway(s), plant control, and essential sensing so that SCADA/DAS/PPC connectivity and fault reporting are maintained during transient disturbances. Surge protection, transient suppression, grounding, and bonding features are integrated into the auxiliary distribution to meet applicable electrical codes and to protect sensitive electronics.

### Control and Communication System

Each distributed control panel provides operators or upper-level systems with centralized access to monitoring and control functions for the string inverters, BOS, and protection systems. The distributed control panels may contain low-voltage control circuits, input/output (I/O) modules, communication devices, and local human-machine interface (HMI) elements, enabling efficient system oversight, parameter adjustment, and diagnostics.

In some embodiments, the system further includes one or multiple control centers that function as communication gateways between the string inverters and upper-level power plant controllers (PPCs), data acquisition systems (DAS), and/or supervisory control and data acquisition (SCADA) systems. In other embodiments, the system may be operated without a dedicated control center, and the communication functions can be integrated into one or more of the distributed control panels.

When provided, a control center enables seamless data exchange and integration, allowing operators to monitor and control the PV system remotely through the power plant's main control interface. The control center may collect real-time operational data from each inverter and from other skid-level devices, and communicate such data to the PPC, DAS, or SCADA systems for real-time monitoring, performance analytics, and event logging.

The control center may also receive commands from upper-level control systems, including commands for active power setpoints, reactive power setpoints, curtailment, and other operational parameters based on grid conditions or plant-wide optimization requirements. The control center then distributes corresponding control signals to the individual inverters and/or BOS components. This bidirectional communication capability ensures that the Skidded String solution is compatible with advanced energy management systems, supports predictive maintenance strategies, and enhances overall plant efficiency.

In another aspect, the RS 485 data stream interconnects the communication ports of the string inverters with the communications gateway inside the skid boundary. It carries inverter status, and alarms, and accepts control setpoints using an industrial protocol such as Modbus RTU over shielded twisted pair in half duplex. The conductors are daisy chained with unique node addressing, include biasing and end of line termination for signal integrity, and incorporate galvanic and surge isolation at the inverter and gateway interfaces. The cabling is routed separately from power conductors associated with the LV switchboard and the medium voltage section to reduce noise coupling. Via this link the gateway aggregates and timestamps measurements such as AC power, voltage, current, and temperature, and relays commands including enable/disable, active power limit, and reactive power or power factor targets. The RS 485 path remains within the skid enclosure with appropriately rated penetrations and supports typical data rates over the installed run length, facilitating coordinated operation while maintaining inverter level independence.

The communications gateway is configured to receive inverter event data over the RS 485 stream, normalize and time align the data, and forward the resulting points and controls to one or more supervisory systems such as SCADA, DAS, or PPC using industry standard protocols. The communications gateway provides a bidirectional interface through which supervisory systems can issue limit setpoints, curtailment commands, power factor or reactive power references, and start/stop or enable/disable controls to individual string inverters or to logical groups of those inverters. The communications gateway can implement data buffering, sequence of events time stamping, watchdog and heartbeat monitoring, point mapping, and user authentication to ensure data integrity and command execution traceability while maintaining electrical independence of the inverter feeders aggregated at the LV switchboard.

One embodiment further comprises collecting, at a control center mounted on the skid, real-time operational data from each of the plurality of string inverters and transmitting the operational data to a PPC/DAS/SCADA system. The control center is co-located on the skid with the string inverters and BOS components to minimize field wiring and to provide a single, integrated point for monitoring and control. The control center receives inverter-level monitoring including, but not limited to, instantaneous AC output power, RMS voltage and current, frequency, DC input voltage and current, energy yield, device temperature and thermal status, internal fault codes, isolation switch positions, and OCPD trip indications. Monitoring can also include periodic or on-demand I-V curve data, event logs, and diagnostic data useful for fault isolation and maintenance planning.

The control center aggregates and time-stamps received data, implements local buffering and event-driven reporting, and performs preliminary filtering and alarm correlation to reduce bandwidth while preserving actionable information for supervisory and plant-control systems. Communications from the inverters to the control center are implemented via serial links (e.g., RS-485) or other local communications protocols, and the control center interfaces with a communications gateway to forward aggregated and raw inverter data to plant-level systems (SCADA/DAS/PPC) over Ethernet, fiber, cellular, or other secure wide-area links. The communications gateway provides protocol translation, cybersecurity measures (authentication, encryption), and redundancy or failover paths as required by grid-connection specifications.

In addition to passive monitoring data forwarding, the control center enables supervisory commands from a higher-level controller to be dispatched to individual inverters or groups of inverters for functions including active/reactive power setpoint adjustment, curtailment, ride-through parameter modification, and remote firmware updates. Local logic within the control center can effect immediate protective actions—for example, tripping AC isolation switches or commanding inverter disconnection in response to detected faults—while reporting those actions and associated root-cause data to upstream systems. The skid-mounted control center thus provides a compact, modular interface between inverter-level devices and plant-level control and monitoring systems, facilitating rapid commissioning, streamlined maintenance, and coordinated plant operation in compliance with applicable grid codes.

In one embodiment, the skid-based integrated platform further includes a control center configured to receive one or more commands comprising at least one of an active power setpoint, a reactive power setpoint, or a curtailment command, and to distribute corresponding control signals to the plurality of string inverters. The control center receives commands from an operator interface or from upstream systems such as a SCADA, DAS, or PPC system. The control center forwards control messages to a communications gateway, which translates and routes the messages to inverter-level controllers over a communications link (for example, an RS-485 data stream). The communications gateway aggregates monitoring data from the plurality of string inverters and provides feedback to the control center indicating present active and reactive power, inverter status, and fault conditions.

Active power setpoints received at the control center are distributed either as a facility-level command for apportionment among inverters or as individual inverter-level setpoints. Apportionment is based on inverter capacity, present operating point, temperature, irradiance estimates, or other performance metrics so that the sum of inverter outputs tracks the commanded active power. Reactive power setpoints are similarly distributed, specifying a target kvar per inverter or an aggregate power factor or voltage support objective. Curtailment commands instruct one or more inverters to limit active output to a specified percentage or absolute power level; such commands are realized by adjusting maximum current references, derating inverter MPPT operation, or by opening AC isolation switches and/or operating feeder OCPDs to remove individual inverter feeders from the aggregated distribution bus for maintenance or persistent faults.

During factory acceptance testing of the skid-based integrated platform, the plurality of string inverters are provisioned with communication identities and parameters and are validated for end-to-end bidirectional communications with the control center. Each inverter is assigned a unique network address or identifier (for example, Modbus RTU IDs for RS-485 links and/or IP addresses for Ethernet-enabled devices) and configured with communication parameters including baud rate, parity, stop bits, frame timing, data polling intervals, and any required protocol-specific settings. The communications gateway is configured to translate and route inverter-level communication streams to supervisory systems (SCADA, DAS, PPC) and to enforce any addressing, mapping, and tag naming conventions required by the control center.

Factory testing includes automated and manual verification procedures. Monitoring channels are exercised to confirm delivery of inverter operational data (real power, reactive power, voltage, current, frequency, alarms, temperature, and status bits) from each inverter through the RS-485 link to the communications gateway and onward to the control center. Control and setpoint channels are exercised by issuing test commands from the control center (for example, enable/disable, power setpoint, reactive setpoint, firmware upgrade initiation) and confirming correct receipt and execution at the targeted inverter. Heartbeat and watchdog functionality is validated to ensure timely detection of lost communications and to verify gateway-initiated reconnection behaviors.

End-to-end tests verify alarm and trip propagation, including OCPD trip indications and AC isolation switch status, ensuring that protection events on the skid are visible at the control center and that centralized commands to isolate or re-enable inverter feeders are successfully carried out. Logging of test exchanges is retained for configuration audit and traceability, and configuration files for inverters and the communications gateway are archived with version identifiers. Security-related parameters, such as authentication credentials, access control lists, and encryption settings where supported, are provisioned and tested to meet control center requirements. Acceptance criteria include correct addressing and parameterization on all inverters, successful bidirectional command and monitoring data exchanges without unacceptable packet loss or latency, and documented evidence of functional interoperability with the remote control center prior to shipment or field commissioning.

### Physical Integration and Mechanical Design

The mechanical integration of the above-mentioned components of the Skidded String solution may be arranged on a single skid platform or on multiple mechanically independent but electrically interconnected skid platforms, depending on transportation constraints, site layout, installation sequencing, or thermal and maintenance considerations, as illustrated in FIG. 1.

FIG. 1 shows an exemplary integration of the Skidded String system in which a single skid is constructed to integrate multiple string inverters, multiple integrated BOS and protection systems, multiple auxiliary power transformers and distributed control panels, one step-up MV transformer, and one control center. In this embodiment, all major power conversion, protection, auxiliary, and control components are mechanically mounted on a common skid structure, forming a factory-integrated, transportable unit. This configuration minimizes on-site assembly, reduces field wiring, and enables rapid installation and commissioning.

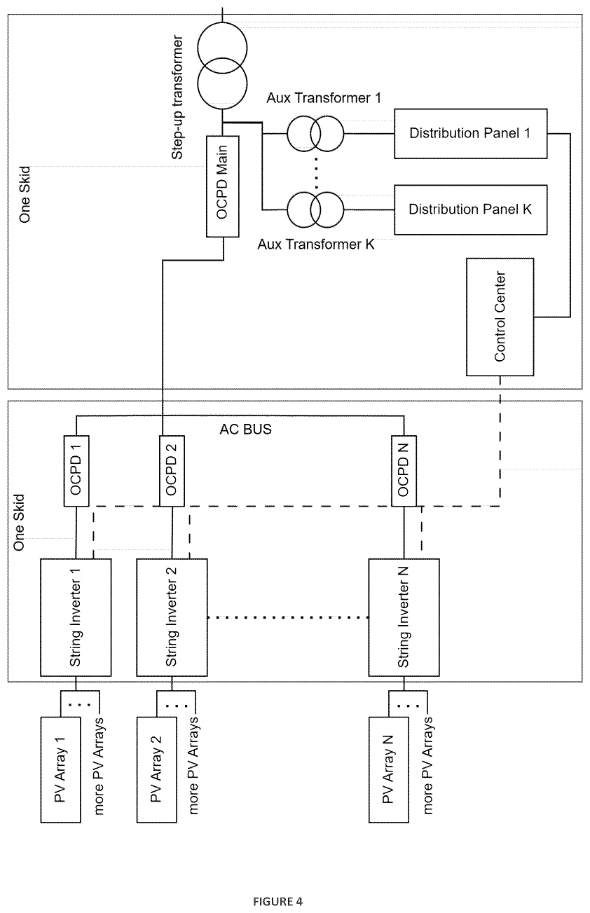

FIG. 4 shows another exemplary integration of the Skidded String system, in which the system is divided across two skids. In this embodiment, a first skid is constructed to integrate one step-up MV transformer, one control center, multiple auxiliary power transformers and distributed control panels, and a main low-voltage overcurrent protection device (OCPD). A second skid is constructed to integrate multiple string inverters, with individual OCPDs provided for each string inverter. The two skids are electrically connected through low-voltage and/or medium-voltage interconnections. This modular skid separation may be advantageous for transportation, site logistics, phased installation, or thermal management, while maintaining the functional benefits of the Skidded String architecture.

In another aspect, the skid boundary delineates the integrated mechanical platform on which the power and control equipment is factory mounted and pre-wired. The boundary represents a transportable structural base with lifting features, mounting rails, cable trays or conduit supports, and a common grounding bus suitable for outdoor installation. Within boundary are the step-up transformer, the secondary-side switchboard with feeder overcurrent protection devices, multiple string inverters, medium-voltage protection and metering components, the RS-485 data stream terminating at the communications gateway, and the AC isolation switches 8 associated with inverter feeders. The skid boundary defines the physical limits of the integrated assembly and its internal interconnections, so that only external terminations for PV DC inputs, the medium-voltage feeder, grounding, and SCADA/DAS/PPC interfaces are required at the site.

The Skidded String system is mechanically integrated on a single metallic skid platform. The skid platform comprises a rigid structural frame and a base plate configured to support, align, and mechanically secure multiple electrical components. The skid may be fabricated from welded steel members and may include lifting features, anchoring interfaces, and structural reinforcements suitable for transportation and field installation.

In the one embodiment, a plurality of string inverters are mounted in a generally linear arrangement along a longitudinal direction of the skid platform. Each string inverter is supported by a dedicated mounting frame or rack structure that elevates the inverter above the skid surface. This elevation provides clearance for cable routing, airflow, and maintenance access. The mounting frames further provide mechanical protection and structural stability during transportation and operation.

The string inverters are electrically connected to PV strings on the DC side and to integrated BOS and protection systems on the AC side. DC-side connections may be routed from one or more DC connection boxes mounted on the skid or positioned adjacent thereto, while AC-side connections are routed toward low-voltage aggregation and protection equipment. In some embodiments, DC and AC routing paths are physically separated using cable trays, conduits, or structural channels attached to the mounting frames or the skid structure.

In the embodiment shown, multiple BOS and protection systems are mechanically integrated on the skid and arranged in panel or cabinet form adjacent to the string inverters. These BOS and protection systems provide individual overcurrent protection and isolation for each string inverter, thereby enabling selective disconnection and maintenance of individual inverters without interrupting operation of the remaining inverters. The BOS and protection systems may be internally interconnected by rigid busbars or insulated conductors.

A step-up medium-voltage transformer is mounted on the skid and electrically connected to the low-voltage aggregation output of the BOS and protection systems. The transformer is positioned to minimize low-voltage cable length and to facilitate efficient power aggregation from the string inverters. In some embodiments, the transformer may include multiple low-voltage windings to separately serve different groups of string inverters mounted on the skid.

In addition, auxiliary power equipment and distributed control panels are mounted on the skid in proximity to the string inverters and BOS components. These auxiliary and control components supply low-voltage power to monitoring, communication, and cooling subsystems, and support local control, data acquisition, and interface functions. In some embodiments, a control center or communication gateway is integrated on the skid and configured to communicate with plant-level controllers, data acquisition systems, or supervisory control and data acquisition systems.

The mechanical arrangement enables factory-level integration of power conversion, protection, transformation, and control components on a single skid, thereby reducing field wiring, improving installation efficiency, and enhancing overall system reliability. It will be understood that the illustrated arrangement is exemplary, and that other mechanical layouts, including different inverter groupings, alternative rack structures, or multi-skid configurations, may be employed without departing from the scope of the present application.

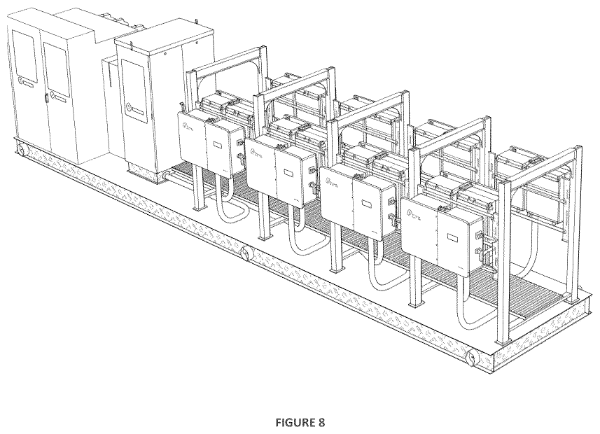

FIG. 8 illustrates an exemplary mechanical realization of the Skidded String inverter system according to an embodiment of the present application showing a three-dimensional isometric view. The embodiment shown represents one possible physical implementation of the Skidded String solution described above and is provided for illustration purposes only. It will be understood that structural arrangements, component quantities, orientations, and enclosure forms may vary without departing from the scope of the present application.

### Electrical Routing and Cable Management

Factory termination and installation reduce on-site labor and variability. Conductors are sized, labeled, and tested prior to shipment; terminations are torqued and marked; harnesses include integrated mechanical strain relief, weatherproofing at external entry points, and keyed connectors to prevent misconnection. Busbar embodiments include insulated covers, bolted or clamp-type tap blocks, and removable localized protective enclosures to facilitate installation and maintenance while maintaining clearance and touch protection in accordance with applicable codes.

The pre-installed cables or busbar interconnection supports the aggregation step by providing an LV aggregation bus with minimal impedance to which each inverter output is connected. Overcurrent protection devices (OCPDs) for each inverter feeder are housed in the LV switchboard adjacent to, or integrated with, the pre-installed terminations. AC isolation switches associated with each inverter feeder are provided either built into the pre-terminated harness, adjacent to the busbar tap, or mounted within the switchboard, enabling selective isolation for maintenance without additional field wiring. The arrangement permits individual inverter isolation while preserving the integrity of the common LV aggregation bus.

Dedicated cable-support hardware such as divider rails, segregated ladder racks, partitioned cable trays, conduit runs, or enclosed channels are used to maintain separation along common routes and at transition points where cables pass through the skid boundary or equipment housings. Where cables pass through bulkheads or cable entry plates, insulated bushings, grommets, or sealed conduits isolate DC and AC conductor groups and prevent physical contact. Removable access panels and labeled pull points are provided at strategic locations to facilitate conductor inspection, testing, and replacement without disturbing adjacent cable groups.

The physical separation reduces electromagnetic interference between DC and AC circuits, minimizes thermal coupling that could impede inverter cooling, and reduces the risk of accidental contact during maintenance. In some embodiments, color-coding and durable labeling differentiate DC trays, AC trays, and control/communication channels, and pull boxes or junction enclosures for DC and AC terminations are separately located. Grounding and bonding practices are implemented for each conductor group consistent with applicable electrical codes, with separate grounding conductors routed in proximity to their respective trays. The routing arrangement supports aggregation of inverter-output AC power onto the secondary winding of the MV step-up transformer and preserves inverter-level isolation and serviceability as part of the skid-based virtual central inverter architecture.

### Factory Assembly and Testing

Factory assembly of the skid-based integrated platform includes complete mechanical integration and the performance of a structured electrical acceptance and functional test program prior to shipment. The plurality of string inverters, the inverter-side switchboard with feeder OCPDs and AC isolation switches, the medium-voltage step-up transformer with associated MV protection and metering components, and the communications gateway are mounted and interconnected on the skid so that final wiring runs, conduit terminations, and mounting hardware are in place and secured. Electrical connection verification comprises visual and torque inspections of all bolted and compression terminations, confirmation of correct conductor sizing and routing, verification of phase sequence and rotation on the inverter-side bus, confirmation of transformer winding polarity and tap position, and verification of correct polarity and labeling for protective relays and metering. Each inspected connection is recorded in an assembly checklist and is traceable to component serial numbers.

Insulation resistance testing is carried out between phase conductors and between each phase conductor and ground in accordance with applicable industry standards and manufacturer recommendations. Tests are performed at specified voltages appropriate to the nominal ratings of the LV and MV circuits, and measured values are evaluated against acceptance criteria. Failures or marginal results prompt remedial actions such as cleaning, re-termination, or replacement of components, followed by retesting. Grounding continuity testing verifies that conductive paths from equipment enclosures, transformer neutrals, and equipment ground conductors to the skid ground point and to external grounding connection points provide uninterrupted continuity and exhibit impedance and resistance values within the required limits. Ground connections are continuity-tested and, where required, measurements of resistance and impedance are recorded to demonstrate compliance with grounding specifications and codes.

Functional testing of the OCPDs includes verification of device type, rating, coordination settings, and mechanical operation. Each feeder OCPD is functionally exercised to confirm trip and isolation operation using secondary injection, simulated faults, or manual trip tests as appropriate for the device design. Confirmed settings and trip curves are recorded and compared with plant coordination studies; where adjustable trip parameters are present, they are set and locked per specification. AC isolation switches associated with inverter feeders are operated to demonstrate maintenance isolation capability and to verify interlocks with inverter controls and OCPDs.

Integrated system functional tests are performed to demonstrate that DC inputs from representative PV string simulators are converted by the string inverters to distribution level AC, that aggregation of distribution level AC operates correctly at the AC distribution switchboard, and that the aggregated distribution level AC is supplied to the step up transformer. Communications testing validates RS 485 links from inverters to the communications gateway and confirms forwarding of data and controls to supervisory systems; firmware versions and configuration files are documented. The skid is tested to demonstrate virtual central inverter behavior, including maintenance of export under simulated single inverter faults by actuating OCPDs to isolate individual inverters while the remaining inverters continue supplying aggregated power. All test results, deviations, corrective actions, and final acceptance signatures are compiled into a factory test report shipped with the skid.

The skid-based integrated platform further includes commissioning the PV power conversion system by verifying DC polarity and continuity, energizing the plurality of string inverters, and confirming protection coordination for inverter-level and main OCPDs. In a typical commissioning sequence, each PV string is inspected and tested prior to inverter connection. DC polarity is confirmed at each string combiner and at each inverter DC input using a calibrated DC voltmeter; continuity and insulation resistance are measured between positive, negative and equipment grounding conductors with an insulation tester to confirm the absence of leakage or unintended conductive paths. Mechanical terminations, connector torques and cable routing are inspected and recorded. Any DC disconnects, fuses or surge protection devices are verified in the open condition while pre-start checks are completed.

After DC verification, inverter firmware, nameplate settings and grid connection parameters are reviewed and, where required, updated via the inverter local interface or by remote communications. The inverters are commissioned in a controlled sequence to limit inrush currents and to permit staged integration to the distribution level aggregation bus. Initial start up is performed with each inverter's AC isolation switch open, allowing the unit to boot, perform self tests and synchronize internal measurements without backfeeding the LV bus. Once internal diagnostics pass, a controlled closure of the associated AC isolation switch connects the inverter to the LV bus. Staged connection can proceed feeder by feeder to monitor bus voltage, current sharing among inverters, harmonic content and inverter control behavior under progressively increasing load.

Throughout commissioning, communications are validated by confirming RS-485 links from inverters to the communications gateway, and gateway forwarding of monitoring and control to SCADA/DAS/PPC. All test results, settings, and certificates of conformance are recorded. Commissioning is performed in accordance with applicable electrical and safety standards and only by qualified personnel using appropriate lockout/tagout and personal protective equipment.

### Operational Methods and Fault Management

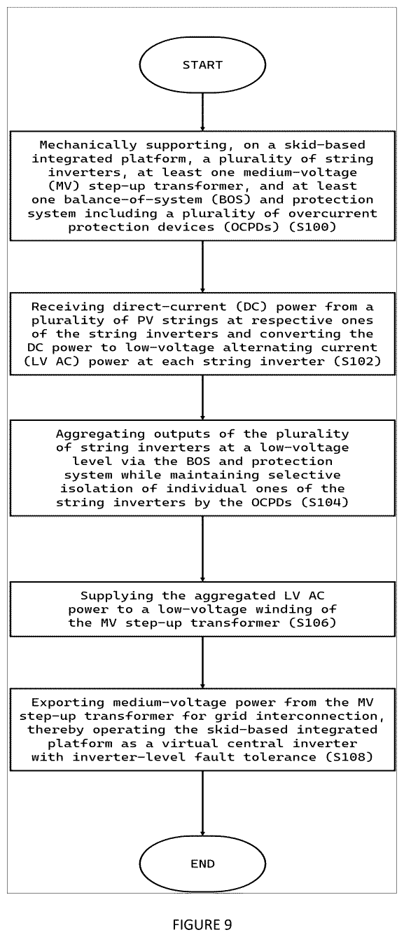

FIG. 9 illustrates a process flow diagram of a method for operating a skid-based integrated platform as a virtual central inverter. In S100, the method mechanically supports, on a skid-based integrated platform, a plurality of string inverters, at least one medium-voltage (MV) step-up transformer, and at least one balance-of-system (BOS) and protection system including a plurality of overcurrent protection devices (OCPDs). In S102, the string inverters receive direct-current power from respective ones of a plurality of PV strings and convert the DC power to alternating current at the LV level (LV AC). In S104, the outputs of the plurality of string inverters are aggregated at the LV level via the BOS and protection system while the OCPDs provide selective isolation of individual ones of the string inverters. In S106, the aggregated LV AC power is supplied to an LV winding of the MV step-up transformer. In S108, medium-voltage power is exported from the MV step-up transformer for grid interconnection, thereby operating the skid-based integrated platform as a virtual central inverter with inverter-level fault tolerance.

In one embodiment, inverter-level monitoring and BOS protection status are used at a control center to perform fault localization prior to actuating selective isolation. Each string inverter continuously supplies time-stamped operational data including AC voltage, AC current, phase angle, power output, harmonic content, DC input voltage and current, device status codes, fault reports, and event logs via an RS-485 link to a communications gateway. The gateway forwards the aggregated monitoring data to plant supervisory systems (SCADA/DAS/PPC), which maintain synchronized logs and a real-time sequence-of-events record. Concurrently, the BOS protection system reports OCPD trip indications, feeder current measurements, and AC isolation switch positions to the same supervisory systems. Medium-voltage protection and metering provide complementary indications of feeder disturbances on the MV side.

Fault localization is performed by correlating inverter monitoring with BOS protection status and temporal sequencing. The supervisory system analyzes deviations from baseline inverter outputs, sudden power collapses, phase imbalances, harmonic spikes, or inverter-reported internal faults, and cross-references those anomalies with contemporaneous OCPD trip events or MV protection actions. Algorithms assign confidence scores to potential fault locations by weighing factors such as rapidity of output change, number of inverters affected, spatial grouping of affected inverters on a common feeder, and presence of OCPD trip signals. Additional diagnostics are executed, including remote inverter pings, requests for detailed fault logs, and commands to perform brief self-tests to refine localization.

When the control center determines that an inverter or feeder is likely faulted with confidence above a predefined threshold, a selective isolation action is initiated. Isolation options include commanding the affected inverter(s) to execute a controlled disconnect, signaling the associated feeder OCPD to open, or commanding an AC isolation switch to operate, in that sequence or as configured. Immediately before and after actuation, the supervisory system verifies isolation by observing expected changes in the monitoring and OCPD status flags. When identification confidence is insufficient, the supervisory system isolates at a higher aggregation level to preserve safety while minimizing impact on remaining inverters.

Local protective devices remain operative as a fallback in the event of communication loss or supervisory malfunction; manual intervention at the skid is available. All localization decisions, commands, and status confirmations are logged for post-event analysis and initiation of maintenance workflows. This coordinated use of inverter monitoring and BOS protection status reduces unnecessary disconnections, accelerates fault remedy, and preserves aggregate export capability of the skid-based platform.

Medium-voltage protection and metering on the MV side are configured to detect and respond to changes in source composition when one or more inverters are isolated, and to preserve anti-islanding, power quality, and protection selectivity. Transformer sizing and LV bus design account for the range of expected aggregated power when subsets of inverters are taken offline, maintaining thermal and electrical margins within rated limits. Fault tolerance is provided at the inverter level, since any inverter fault can be removed via its OCPD without requiring plant-level shutdown; the aggregation and transformer continue operation with reduced capacity. The platform is configured to implement control strategies to re-dispatch remaining inverters to manage voltage, reactive power, and ramping requirements during maintenance, with the communications gateway enabling coordinated plant-level responses.

### Scalable Power Ratings and Parallel Deployment

The aggregating and supplying operations are performed so as to realize approximately 2.5 MW, 3 MW, 5 MW or other power block ratings depending on the number of installed string inverters. For example, when 250 kW-class inverters form the plurality, installing approximately ten such inverters yields an aggregate LV AC capacity on the order of 2.5 MW, installing approximately twelve yields on the order of 3 MW, and installing approximately twenty yields on the order of 5 MW. The platform thus functions as a virtual central inverter, delivering MV export comparable to a centralized inverter while retaining inverter-level redundancy and fault tolerance. The skid-based integration simplifies site installation, reduces wiring and civil footprint, and facilitates pre-commissioning of inverter, transformer, BOS, protection, and communications subsystems prior to deployment.

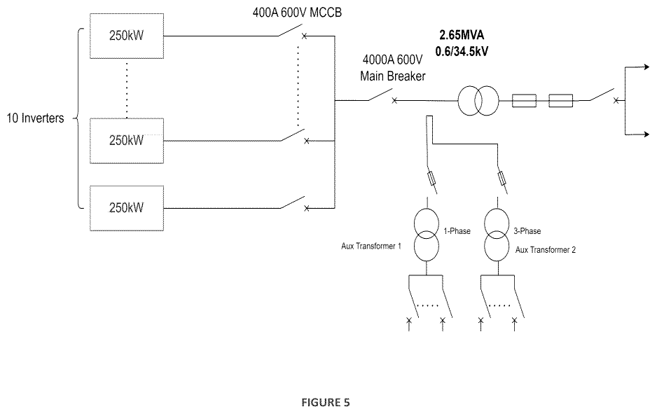

FIG. 5 shows a schematic diagram of a Skidded String system provided in one embodiment of the present application and illustrates a 2.5 MW exemplary layout of the Skidded String inverter system. This embodiment may include ten string inverters, BOS and protection capacity sized for the aggregated output, and a transformer with corresponding power rating, while retaining the same functional architecture and operational principles described above. FIG. 6 shows a 5 MW exemplary layout with twenty string inverters grouped into two sets of ten, each set feeding a separate 4000 A main breaker, with the two main breakers combining to supply a 5.3 MVA transformer with dual LV windings. These embodiments demonstrate that the Skidded String solution can be flexibly scaled by adjusting the number of inverters, switchboards, transformers, and auxiliary components without altering the underlying system topology.

A plant-level PPC/DAS/SCADA system exchanges setpoints and receives monitoring data from each skid's communications gateway. Inverter-level RS-485 or equivalent serial/data links aggregate at the gateway, which translates and forwards normalized operational data and accepts plant-level commands. The PPC issues coordinated setpoints for active power, reactive power (or power factor), ramp rates, maximum fault current contribution limits, and curtailable profiles across the plurality of skids. Coordinated setpoint distribution supports load-sharing, economic dispatch, voltage support, and compliance with grid interconnection requirements.

Setpoint coordination uses periodic monitoring and supervisory commands to distribute instantaneous and scheduled power among skids according to configured allocation rules (pro rata by capacity, performance-based, or prioritized). During normal operation the PPC treats the ensemble of skids as a virtual central inverter, commanding aggregate power targets while allowing inverter-level control to maintain local MPPT and fault isolation. If a skid or individual string inverter becomes unavailable, OCPDs and AC isolation switches permit selective disconnection while the PPC dynamically reallocates power setpoints to remaining skids to meet plant-level objectives and to respect MV feeder limits. This provides inverter-level fault tolerance and graceful degradation of plant output.

Protection and metering on the MV side coordinate with the PPC to ensure compliance with ride-through, anti-islanding, and fault-clearing protocols. MV protection relays provide status and trip events to the PPC for fast supervisory response. The mechanical skid boundary standardizes electrical and control interfaces, simplifying parallel deployment, commissioning, and replacement. Control logic supports hierarchical control modes including independent local voltage regulation, droop-sharing, and centralized dispatch, selectable based on grid requirements. Redundant communications paths and supervisory redundancy can be provided to increase availability. The described parallel-skid architecture enables modular scaling of plant capacity, simplified maintenance, and greater operational resilience while presenting a unified, controllable aggregate to the grid operator.

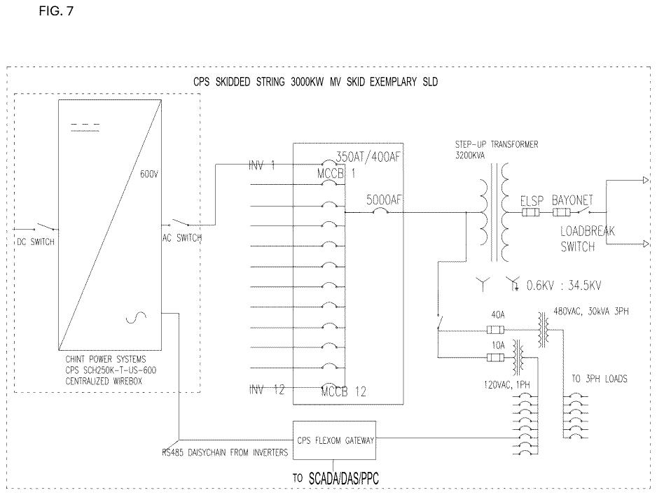

FIG. 7 shows a detailed single-line diagram of an exemplary realization of a Skidded String PV system utilizing CPS SCH250K-T-US-600 string inverters. In this embodiment, multiple CPS SCH250K-T-US-600 inverters are electrically connected to integrated BOS and protection systems and are collectively coupled to the low-voltage side of a step-up MV transformer. The single-line diagram illustrates representative electrical connections between PV arrays, string inverters, DC and AC protection devices, low-voltage aggregation points, auxiliary power supplies, and medium-voltage grid interconnection equipment. It will be understood that the illustrated inverter model and ratings are exemplary, and other inverter models, power ratings, and voltage classes may be employed without departing from the scope of the present application.

The embodiments illustrated in FIGS. 1 through 9 demonstrate that the Skidded String solution provides a flexible, scalable, and factory-integrated architecture capable of supporting a wide range of PV plant capacities and configurations, while maintaining the technical advantages of both string inverter granularity and centralized power aggregation.

### Alternative Embodiments and Variations

The present application is not limited to the specific embodiments described above. Various variations, modifications, and improvements may be made without departing from the scope of the invention.

In some embodiments, the Skidded String system may be implemented on a single skid or on multiple mechanically separate but electrically interconnected skids. The system may be fully or partially enclosed within containers, cabinets, or shelters, and may include environmental control features depending on site conditions. The choice between single-skid and multi-skid configurations may be driven by transportation constraints, thermal management requirements, phased installation schedules, or site-specific logistics considerations.

The total system capacity, inverter quantity, inverter ratings, voltage levels, and transformer configurations may be varied to accommodate different project requirements. String inverters within a single system may have identical or differing electrical characteristics. For example, a skid may incorporate inverters of different power ratings to optimize performance under varying irradiance conditions or to accommodate heterogeneous PV array configurations. The system may be configured for nominal capacities ranging from approximately 1 MW to 10 MW or more, with typical implementations at 2.5 MW, 3 MW, 5 MW, or other standardized power block sizes.

The medium-voltage transformer may include one or more low-voltage windings, or multiple transformers may be used for redundancy or parallel aggregation. In some embodiments, a single transformer with a single LV winding aggregates all string inverter outputs. In other embodiments, a transformer with two or more LV windings provides electrical segregation between inverter groups, enabling independent operation, improved fault tolerance, or compliance with specific utility interconnection requirements. Alternative embodiments may employ multiple medium-voltage transformers in parallel to increase aggregate capacity, provide redundancy, or support phased commissioning.

Low-voltage power aggregation may be implemented using cables, busbars, bus ducts, or combinations thereof. In some embodiments, rigid copper or aluminum busbars provide low-impedance, high-reliability aggregation within a compact switchboard footprint. In other embodiments, insulated cables or flexible bus ducts are employed to simplify routing, accommodate thermal expansion, or facilitate modular expansion. Hybrid approaches combining busbar sections for main aggregation and cable feeders for individual inverter connections may also be implemented.

Balance-of-system and protection functions may be centralized or distributed and implemented using various protection technologies, including circuit breakers, fused disconnects, or solid-state protection devices. Additional protection, monitoring, or diagnostic functions may be incorporated as required. In some embodiments, advanced protection schemes such as arc-fault detection, ground-fault monitoring, or insulation monitoring devices are integrated at the inverter level, DC connection box, or switchboard level. Real-time monitoring of bus voltage, current, harmonic content, and thermal conditions may be implemented to support predictive maintenance and advanced diagnostics.

DC-side architectures may include one or more DC connection boxes with prewired connections to string inverters, or may omit DC connection boxes entirely. cabling may be implemented using preterminated harnesses, rigid conduits, or flexible routing methods. In embodiments without a centralized DC connection box, each string inverter may receive DC input directly from field-installed DC combiners or from PV strings routed individually to the skid. In other embodiments, multiple DC connection boxes are provided to segregate DC inputs by array location, string configuration, or maintenance zones.

Control and communication functions may be centralized or distributed and implemented using industrial controllers, embedded systems, or distributed control architectures. Communication may employ wired or wireless protocols and support advanced monitoring, grid-support, and optimization functions. In some embodiments, the control center is implemented as a dedicated industrial computer or programmable logic controller (PLC) with redundant processing and communication interfaces. In other embodiments, control functions are distributed across multiple inverter-level controllers with peer-to-peer communication. Communication protocols may include Modbus RTU/TCP, DNP3, IEC 61850, MQTT, or proprietary protocols depending on plant integration requirements. Wireless communication using cellular, radio, or satellite links may be employed for remote sites or for redundancy.

Cooling, transportation, installation, and commissioning methods may be adapted to meet project-specific requirements. In some embodiments, string inverters and BOS components are cooled by natural convection or ambient airflow. In other embodiments, forced-air cooling using fans, ducted ventilation, or air conditioning systems is provided to support operation in high-ambient-temperature environments. Thermal management may include heat sinks, ventilation louvers, air filters, and temperature monitoring to ensure reliable operation across a wide range of environmental conditions.

The Skidded String architecture may further be extended to support hybrid systems such as PV-plus-storage without departing from the underlying invention. In hybrid embodiments, energy storage systems comprising batteries, power conversion systems (PCS), and battery management systems (BMS) may be integrated on the same skid or on adjacent electrically-coupled skids. The control center may coordinate dispatch between PV generation and energy storage to provide grid services such as frequency regulation, peak shaving, or time-of-use energy arbitrage. DC-coupled or AC-coupled storage architectures may be implemented depending on system requirements.

Additional functional enhancements may include advanced grid support capabilities such as dynamic voltage support, frequency response, ramp-rate control, and curtailment. The system may incorporate meteorological sensors, irradiance monitoring, and performance modeling to optimize energy yield and support plant-level energy management. Remote firmware update capabilities, cybersecurity features, and encrypted communication may be implemented to support secure remote operation and maintenance.

### Manufacturing and Implementation Details

In practical implementation, the Skidded String system is preferably manufactured using a factory-based integration process. A structural skid frame is first fabricated using welded or bolted steel members designed to support the mechanical loads of the string inverters, transformers, BOS and protection equipment, auxiliary power components, and control systems. The skid structure may be treated with corrosion-resistant coatings, such as galvanization or industrial-grade paint systems, to enable long-term outdoor deployment.

The skid frame is designed to meet applicable structural codes and standards, including load ratings for static equipment weight, dynamic transportation loads, wind loads, and seismic loads as required by the project location. Lifting features such as lifting lugs, padeyes, or integrated lifting beams are provided to enable safe crane handling during manufacturing, transportation, and installation. Anchoring interfaces such as bolt-down patterns or embedded anchor points are incorporated to facilitate secure foundation attachment at the project site.

Once the skid structure is prepared, major electrical components are mechanically mounted onto the skid according to a predefined layout. This may include mounting multiple string inverters on inverter racks or frame structures, installing BOS and protection switchboards, positioning one or more medium-voltage transformers, and securing auxiliary power transformers, DC connection boxes, distributed control panels, and control centers. Mechanical mounting methods may include bolted interfaces, vibration-isolating pads, and alignment features to ensure structural integrity during transport and operation.

String inverters are typically mounted on elevated rack structures or mounting frames that provide clearance for cable routing beneath the inverters, facilitate airflow for cooling, and enable ergonomic access for maintenance. Mounting hardware is torqued to specified values and documented in manufacturing records. Switchboards, transformers, and auxiliary equipment are positioned to minimize cable run lengths, optimize thermal performance, and provide clear access pathways for operation and maintenance personnel.

In some embodiments, equipment is mounted with shock-absorbing mounts or isolation pads to reduce vibration transmission during transportation. Temporary bracing or restraints may be installed during manufacturing to prevent component movement or damage during shipment, and are removed or released upon site installation.

Electrical interconnection is then performed at the factory. Low-voltage AC connections between string inverters and BOS switchboards may be made using pre-cut and terminated power cables or busbar systems. DC interconnections between DC connection boxes and string inverters may be realized using prewired cable harnesses, while auxiliary power and control wiring are routed through dedicated cable trays or conduits. Communication wiring between inverters, protection devices, and the control center is installed and labeled to facilitate commissioning and future maintenance.

Power cable terminations are made using compression lugs, mechanical connectors, or bolted terminations appropriate for the conductor size and current rating. All terminations are torqued to manufacturer specifications using calibrated torque tools, and torque values are recorded. Phase identification, circuit labeling, and equipment tagging are performed in accordance with project-specific labeling standards and applicable electrical codes. Cables are routed through segregated cable trays or conduits to maintain physical separation between DC circuits, AC power circuits, and control/communication circuits.

Busbar connections, where employed, are made using bolted joints with appropriate contact surfaces, anti-oxidation compounds, and belleville washers or spring washers to maintain long-term contact integrity. Busbar joints are inspected visually and thermographically during factory testing to verify proper assembly.

Grounding and bonding connections are made to establish electrical continuity between all equipment enclosures, structural members, cable trays, and a central skid grounding point. Grounding conductors are sized in accordance with applicable codes and are connected using compression connectors, exothermic welds, or bolted joints. A main grounding terminal or ground bar is provided on the skid for connection to the site grounding system.

In some embodiments, the Skidded String system undergoes factory-level configuration and testing prior to shipment. Configuration may include assigning network addresses to string inverters, setting protection parameters, configuring auxiliary power circuits, and loading control logic or communication protocols into the control center or distributed control panels.

Each string inverter is configured with a unique communication address (e.g., Modbus RTU node ID or IP address) and is programmed with operational parameters such as voltage and frequency set points, power factor targets, ramp rates, and protection thresholds. Protection devices such as circuit breakers and relays are set or programmed with coordination curves, trip thresholds, and time delays to achieve selective coordination. Auxiliary power distribution circuit breakers are labeled and configured for appropriate load protection.

Factory testing procedures may include mechanical inspections, verification of electrical connections, insulation resistance testing, grounding continuity checks, and functional testing of protection devices such as circuit breakers or disconnect switches. Communication testing may be performed to confirm data exchange between string inverters and the control center, as well as communication to simulated or actual plant-level controllers or SCADA systems. In some cases, partial functional energization tests or subsystem-level power tests may be conducted in a controlled environment.

Mechanical inspections verify that all equipment is securely mounted, that mounting hardware is properly torqued, that cable routing is neat and adequately supported, and that all access panels, doors, and covers are properly installed and latched. Visual inspection confirms correct phase identification, labeling, and tagging.

Electrical connection verification includes inspection of all power and control terminations, confirmation of conductor sizing and insulation rating, verification of phase sequence and rotation, and confirmation of correct polarity for DC circuits and protective relaying. Insulation resistance testing (megger testing) is performed on AC and DC power circuits at appropriate test voltages to verify insulation integrity. Grounding continuity is verified by measuring resistance between equipment enclosures and the main skid grounding point; measured values are compared against acceptance criteria and documented.

Functional testing of overcurrent protection devices includes manual operation of circuit breakers and disconnect switches to verify mechanical operation, electrical continuity when closed, and isolation when open. Trip testing may be performed using secondary injection techniques or simulated fault signals to verify correct operation of electronic trip units and protective relays. Communication testing includes verification of RS-485 or Ethernet links, confirmation of data polling and response from each string inverter, and end-to-end testing of command and control functions from a simulated or actual supervisory system.

All factory testing results, including inspection checklists, test measurements, configuration parameters, and any non-conformances or corrective actions, are documented in a factory acceptance test (FAT) report. The FAT report is reviewed and approved by quality assurance personnel and, where applicable, by customer representatives or third-party inspectors. Upon successful completion of factory testing, the skid is prepared for shipment.

After factory assembly and testing, the Skidded String system may be prepared for transportation as a single integrated unit or as multiple modular skids. Preparation may include temporary bracing, protective packaging, and securing movable components. The skid may be transported to the project site using standard freight or heavy-haul transportation methods.

Transportation preparation includes installation of temporary bracing or restraints on inverters, transformers, switchboards, and other equipment to prevent movement or damage during transit. Cable trays and conduits are inspected to ensure all cables are adequately secured. Doors, panels, and access covers are latched and may be additionally secured with shipping brackets or tape. In some embodiments, environmental protection such as shrink-wrap, tarpaulins, or weatherproof covers is applied to protect equipment from moisture, dust, or debris during transportation and storage.

Depending on skid size and weight, transportation may be accomplished using flatbed trucks, lowboy trailers, or, for very large or heavy skids, specialized heavy-haul transporters. Transportation routes are planned in advance to ensure adequate clearance for overhead obstructions, bridge load ratings, and road width. Permits may be required for oversize or overweight loads. In some cases, skids are transported by rail or by barge for long-distance or international shipments.

At the site, installation may include placing the skid onto prepared foundations, anchoring the skid, and connecting the grounding system. Field electrical work may be limited to connecting DC PV strings to the DC connection box, connecting the medium-voltage output of the transformer to the site's MV collection system, and establishing auxiliary power and communication links as required. The factory-integrated nature of the system significantly reduces field wiring and labor requirements compared to fully distributed inverter installations.

Site foundations are typically constructed as reinforced concrete pads or grade beams designed to support the skid weight and operational loads. Foundation design accounts for soil conditions, seismic requirements, and frost depth as applicable. Anchor bolts or other anchoring systems are embedded in the foundation or installed using post-installed anchors, and the skid is positioned, leveled, and secured.

Grounding connections are made between the skid grounding point and the site grounding system, which may include ground rods, ground grids, or connections to structural grounding electrodes. Grounding resistance is measured and verified to meet applicable code requirements.

DC field wiring from PV arrays is routed to the skid DC connection box or individual inverter via underground conduit, direct-burial cable, or overhead cable tray, depending on site design. DC conductors are landed on the DC connection box input terminals in accordance with circuit labeling and polarity markings. Prewired DC cables from the DC connection box to the string inverters, which were installed during factory assembly, eliminate the need for field DC wiring between the DC connection box and inverters.

Medium-voltage connections from the skid transformer to the site MV collection system are made by qualified utility or electrical contractors in accordance with applicable codes and utility requirements. MV terminations may include cable terminations, pad-mounted switchgear connections, or transformer connections depending on the site electrical architecture. Auxiliary power and communication connections are made to provide station service power and to integrate the skid control center with plant-level SCADA, DAS, or PPC systems.

Commissioning activities may include verification of DC polarity and continuity, inverter startup and synchronization checks, confirmation of protection coordination, and integration of the Skidded String control system with plant-level power plant controllers, data acquisition systems, or SCADA systems. Operating parameters such as power limits, reactive power setpoints, and grid-support functions may be configured to comply with utility or regulatory requirements.

DC commissioning begins with verification of open-circuit voltage and polarity for each PV string at the DC connection box. Insulation resistance testing is performed on DC circuits to verify proper insulation and absence of ground faults. DC disconnect devices and fuses, if present, are visually inspected and verified to be in the correct state (open during pre-commissioning checks).

Inverter commissioning includes verification of firmware versions, configuration parameter review, and initial energization. Inverters are started in a controlled sequence, typically one at a time, to allow monitoring of each inverter's startup behavior, synchronization with the AC bus, and power output. AC voltage, frequency, and phase sequence are verified at the inverter output and at the LV switchboard. Inverter control functions such as MPPT, power factor control, and response to setpoint commands are tested and verified.

Protection coordination is verified by reviewing protection device settings and coordination curves, and by performing functional tests of protective relays and circuit breakers. Simulated fault conditions or trip tests may be performed to confirm that feeder-level protection operates correctly without nuisance tripping of upstream devices. MV protection and metering on the transformer secondary are tested and verified for correct operation, including anti-islanding protection, overvoltage/undervoltage protection, and overcurrent protection.

Communication commissioning includes verification of RS-485 or Ethernet links between inverters and the control center, verification of data polling accuracy, and integration with plant-level SCADA, DAS, or PPC systems. Communication protocol configuration, data point mapping, and alarm forwarding are tested and verified. Setpoint commands such as active power curtailment, reactive power control, and inverter enable/disable are tested from the plant-level control system to confirm end-to-end control functionality.

Operating parameters are configured in accordance with utility interconnection agreements and grid code requirements. This may include setting voltage and frequency ride-through parameters, ramp rate limits, power factor targets or reactive power ranges, and maximum export limits. Plant-level control strategies such as curtailment schedules, demand response participation, or energy storage coordination (if applicable) are configured and tested.

During normal operation, each string inverter operates independently while contributing power to a centralized low-voltage aggregation point on the skid. Faults affecting individual inverters may be isolated by inverter-level or switchboard-level protection devices without interrupting operation of other inverters on the skid. The control center enables centralized monitoring, diagnostics, and event logging, supporting efficient operation and predictive maintenance.

Operational monitoring includes real-time tracking of inverter output power, energy production, DC input conditions, AC bus voltage and frequency, transformer loading, and auxiliary system status. Alarms and fault indications are logged and forwarded to plant-level monitoring systems. Performance metrics such as availability, capacity factor, and performance ratio are calculated and reported to support ongoing performance analysis and optimization.

In practical use, the Skidded String system functions as a modular building block within a photovoltaic power plant. Multiple skids may be deployed in parallel to scale plant capacity. Maintenance activities may be performed at the inverter level, skid level, or plant level, depending on the nature of the service required. The centralized layout facilitates access to inverters and protection devices, reduces troubleshooting time, and improves overall system availability.

Routine maintenance activities include visual inspection of equipment, cleaning of air filters (if equipped), verification of cooling system operation, inspection of cable and busbar connections, thermal imaging to detect loose connections or overheating components, and functional testing of communication systems. Inverter maintenance may include firmware updates, replacement of cooling fans, or replacement of internal components in accordance with manufacturer maintenance schedules.

Corrective maintenance in response to faults or alarms typically begins with fault localization using inverter monitoring, BOS status indications, and event logs from the control center. Once a fault is localized to a specific inverter or circuit, that inverter can be selectively isolated using its associated AC isolation switch and feeder OCPD, allowing the remainder of the skid to continue operating. The isolated inverter can then be safely accessed for troubleshooting, repair, or replacement.

Inverter replacement, when required, is facilitated by the modular architecture. The faulted inverter is electrically isolated, disconnected from DC and AC circuits, mechanically removed from its mounting frame, and replaced with a new or refurbished unit. The replacement inverter is mechanically secured, electrically reconnected, configured with appropriate communication and control parameters, and recommissioned following verification procedures. The centralized skid layout and prewired DC connections significantly reduce the time required for inverter replacement compared to distributed field installations.

The manufacturing and implementation approach described above enables consistent quality, reduced installation timelines, improved safety, and lower total cost of ownership for utility-scale PV installations, while supporting a wide range of configurations, capacities, and site conditions.

The Skidded String inverter system offers significant commercial advantages across a wide range of photovoltaic applications and markets. The following sections describe key commercial applications and the competitive advantages provided by the invention in each application area.

The Skidded String system is well suited for large utility-scale PV plants where high power density, scalability, and minimized downtime are critical. The integrated skid architecture reduces BOS costs, simplifies installation, and improves system availability through inverter-level fault isolation. Utility-scale plants typically range from 10 MW to several hundred MW in capacity and require reliable, cost-effective power conversion infrastructure that can be deployed rapidly and maintained efficiently over the total operational life.

The factory-integrated nature of the Skidded String system reduces on-site electrical labor compared to fully distributed string inverter installations, resulting in shorter construction schedules and lower labor costs. The centralized architecture reduces the number of AC combiner boxes, disconnect switches, and field-installed cable runs, thereby reducing material costs and improving system reliability. Inverter-level fault isolation ensures that a fault in one inverter does not impact the operation of other inverters on the skid, maintaining high plant availability even during maintenance or component failures.

The Skidded String system can be configured as a single compact skid or as multiple smaller skids to fit within available space while providing the performance and reliability advantages of factory integration. The reduced footprint and centralized layout minimize the area required for electrical equipment, allowing more space for PV arrays. The modular architecture supports phased installation, enabling C&I customers to expand capacity over time as energy demand grows or as financing becomes available.

The modular skid-based design allows existing plants to be expanded or repowered with minimal disruption. Additional skids can be added alongside existing infrastructure, enabling capacity upgrades without major redesign or system downtime. Repowering projects, in which aging inverters or transformers are replaced with newer, more efficient equipment, benefit from the standardized skid architecture, which allows direct replacement of older central inverters or distributed string inverter installations with Skidded String units.

The factory-integrated design ensures compatibility with existing medium-voltage infrastructure, grounding systems, and control systems, minimizing the scope of field modifications. The ability to add capacity in standardized 2.5 MW, 3 MW, or 5 MW blocks simplifies engineering and procurement and reduces project risk. Expansion projects can be completed quickly, allowing plant owners to capture additional revenue from increased generation capacity with minimal downtime.

Factory-integrated skids can be manufactured and tested off-site and installed rapidly at the project location. This makes the invention particularly attractive for projects with tight construction schedules or phased deployment requirements. Fast-track projects, which are driven by interconnection deadlines, power purchase agreement milestones, or investment tax credit deadlines, benefit from the reduced field installation time and simplified commissioning process.

Phased developments, in which plant capacity is built out over multiple stages, benefit from the modular skid architecture, which allows each phase to be deployed as a self-contained unit with minimal interdependencies. Skids for later phases can be manufactured in parallel with earlier-phase construction, reducing overall project duration. The standardized design and factory testing reduce commissioning risk and ensure consistent performance across all phases.

By centralizing BOS, protection, and prewired inverter connections, the Skidded String system significantly reduces on-site electrical labor, making it suitable for regions with high labor costs, limited skilled workforce availability, or challenging site conditions. Remote or difficult-to-access sites, such as desert locations, mountainous terrain, or sites with limited infrastructure, benefit from the reduced field labor requirements and the ability to deploy fully integrated, pre-tested equipment.

Regions with high labor costs, such as developed markets in North America, Europe, and Asia-Pacific, benefit from the reduced installation labor, which can represent 20-30% of total project cost in distributed inverter installations. Regions with limited availability of skilled electrical labor benefit from the simplified installation process, which requires less specialized expertise and reduces the risk of installation errors. Sites with challenging environmental conditions, such as extreme temperatures, high altitude, or corrosive atmospheres, benefit from the factory-controlled assembly and testing environment, which ensures consistent quality and reduces the impact of site conditions on equipment performance.

The flexibility of string inverters combined with centralized aggregation allows the system to adapt to sites with uneven terrain, multiple array orientations, or non-uniform string configurations, while still maintaining a compact, centralized power block. Sites with irregular topography, shading from nearby structures or vegetation, or multiple ground conditions benefit from the string-level independence and modular inverter architecture, which allows each inverter to operate at its optimal power point independently of other inverters.

The centralized skid location can be positioned to minimize cable run lengths from the PV arrays while providing convenient access for maintenance. Multiple skids can be distributed across a large site to balance cable losses, voltage drop, and collection system efficiency. The DC connection box and prewired DC cabling simplify field wiring even in complex layouts, reducing installation time and cost.

Inverter-level fault isolation and centralized monitoring enable continued partial operation during maintenance or fault events, improving overall plant availability compared to traditional central inverter architectures. Projects with stringent availability requirements, such as those with performance-based power purchase agreements, revenue guarantees, or participation in capacity markets, benefit from the fault-tolerant architecture and rapid fault localization capabilities.

The ability to isolate and service individual inverters without shutting down the entire skid reduces the impact of component failures on energy production. The centralized control and monitoring system enables rapid fault detection, diagnosis, and response, minimizing downtime. The factory-tested and pre-commissioned equipment reduces the risk of installation-related failures and improves long-term reliability.

The centralized control and communication gateway enables compliance with a wide range of grid codes and interconnection requirements, allowing the system to be deployed across different markets with minimal architectural changes. Grid codes and utility interconnection requirements vary significantly across regions and utilities, with requirements for voltage and frequency ride-through, reactive power support, ramp rate control, power quality, and communication protocols.

The Skidded String control center and communications gateway provide a flexible, programmable platform for implementing grid code requirements. Software updates and parameter changes can be implemented without hardware modifications, allowing the same skid architecture to be deployed in multiple markets. The centralized control architecture simplifies compliance verification and testing, reducing the time and cost of interconnection approval.

The standardized skid approach supports repeatable deployment across multiple projects, simplifying engineering, procurement, commissioning, and long-term fleet-level operation and maintenance, which provides competitive operational advantages. Large engineering, procurement, and construction (EPC) contractors and owner-operators with multi-site portfolios benefit from the standardized design, which allows common engineering standards, procurement specifications, construction procedures, and maintenance practices to be applied across multiple projects.

The standardized architecture reduces engineering effort for each subsequent project, as electrical designs, protection coordination studies, and control system integration can be reused with minimal modifications. Procurement benefits from volume purchasing of standardized skid units, reducing equipment costs and lead times. Construction benefits from repeatable installation procedures and lessons learned from previous projects. Operations and maintenance benefits from standardized spare parts inventories, common training programs, and fleet-level performance monitoring and optimization.

The ability to deploy a common platform across multiple projects reduces project risk, improves cost predictability, and enhances long-term operational performance. The Skidded String system thereby provides competitive advantages to large EPC contractors and owner-operators seeking to optimize their project portfolios and reduce lifecycle costs.

The embodiments described herein provide a comprehensive, scalable, and factory-integrated Skidded String inverter system that combines the modularity and fault tolerance of string inverters with the cost efficiency and operational simplicity of central inverters, thereby enabling efficient, reliable, and maintainable photovoltaic power generation at utility scale.

1. A Skidded String photovoltaic (PV) power conversion system, comprising:
a skid-based integrated platform that mechanically supports and electrically interconnects:
multiple string inverters;
at least one medium-voltage (MV) step-up transformer;
at least one balance-of-system (BOS) and protection system including multiple overcurrent protection devices (OCPDs);
and wherein the outputs of the multiple string inverters are aggregated at a low-voltage level and supplied to the MV transformer so that the skid-based platform operates as a virtual central inverter while maintaining independent inverter-level operation.

2. The PV power conversion system of claim 1, wherein each string inverter is configured for independent operation and selective isolation without interrupting operation of remaining string inverters.

3. The PV power conversion system of claim 1, wherein the MV transformer includes one or more low-voltage windings, each low-voltage winding being connected to a respective group of string inverters.

4. The PV power conversion system of claim 1, wherein the BOS and protection system is implemented as one or more low-voltage switchboards.

5. The PV power conversion system of claim 4, wherein each string inverter output is connected to a dedicated overcurrent protection device within the switchboard.

6. The PV power conversion system of claim 4, further comprising one or more main overcurrent protection devices between the switchboard and the low-voltage side of the MV transformer.

7. The PV power conversion system of claim 1, further comprising at least one DC connection box mounted on the skid.

8. The PV power conversion system of claim 7, wherein the DC connection box includes prewired DC cables extending to respective DC input terminals of the string inverters.

9. The PV power conversion system of claim 7, wherein PV strings from a field installation terminate at the DC connection box prior to connection to the string inverters.

10. The PV power conversion system of claim 7, wherein the DC connection box includes one or more of DC disconnect devices, string fuses, current monitoring components, or surge protection devices.

11. The PV power conversion system of claim 1, further comprising at least one control center configured as a communication gateway between the string inverters and an upper-level power plant controller, data acquisition system, or supervisory control and data acquisition system.

12. The PV power conversion system of claim 11, wherein the control center is configured to collect real-time operational data from each string inverter and transmit the data to the upper-level system.

13. The PV power conversion system of claim 11, wherein the control center is configured to receive control commands from the upper-level system and distribute the commands to the string inverters.

14. The PV power conversion system of claim 1, further comprising one or more auxiliary power transformers configured to supply low-voltage power to control, monitoring, communication, or cooling equipment.

15. The PV power conversion system of claim 14, further comprising multiple distributed control panels electrically supplied by the auxiliary power transformers.

16. The PV power conversion system of claim 1, wherein the skid-based integrated platform comprises a single skid mechanically supporting the string inverters, MV transformer, BOS and protection system, auxiliary power equipment, and control center.

17. The PV power conversion system of claim 1, wherein the skid-based integrated platform comprises multiple mechanically separate but electrically interconnected skids.

18. The PV power conversion system of claim 17, wherein a first skid integrates the MV transformer and control center, and a second skid integrates the string inverters and inverter-level protection devices.

19. The PV power conversion system of claim 1, wherein the skid-based integrated platform is factory-assembled and factory-tested prior to shipment for field installation.

20. The PV power conversion system of claim 1, wherein multiple skid-based integrated platforms are deployed in parallel to form a scalable photovoltaic power plant architecture.

21. A method of operating a photovoltaic (PV) power conversion system as a virtual central inverter while maintaining inverter-level independence, comprising:
mechanically supporting, on a skid-based integrated platform, a plurality of string inverters, at least one medium-voltage (MV) step-up transformer, and at least one balance-of-system (BOS) and protection system including a plurality of overcurrent protection devices (OCPDs);
receiving direct-current (DC) power from a plurality of PV strings at respective ones of the string inverters and converting the DC power to low-voltage alternating current (LV AC) power at each string inverter;
aggregating outputs of the plurality of string inverters at a low-voltage level via the BOS and protection system while maintaining selective isolation of individual ones of the string inverters by the OCPDs;
supplying the aggregated LV AC power to a low-voltage winding of the MV step-up transformer;
exporting medium-voltage power from the MV step-up transformer for grid interconnection, thereby operating the skid-based integrated platform as a virtual central inverter with inverter-level fault tolerance.
